(19) United States
(12) Patent Application Publication
(10) Pub. No.: US 2022/0411944 A1
(43) Pub. Date: Dec. 29, 2022

(54) CATALYST COMPOSITIONS, PROCESSES FOR FORMING THE CATALYST COMPOSITIONS, AND USES THEREOF

(71) Applicant: Honda Motor Co., Ltd., Tokyo (JP)

(72) Inventors: Avetik HARUTYUNYAN, Santa Clara, CA (US); Shutang CHEN, Livermore, CA (US); Xufan LI, Fremont, CA (US)

(21) Appl. No.: 17/709,130

(22) Filed: Mar. 30, 2022

Related U.S. Application Data
(60) Provisional application No. 63/213,917, filed on Jun. 23, 2021.

(51) Int. Cl. C25B 11/089; C25B 1/04

(52) U.S. Cl. CPC C25B 11/089; C25B 1/04; C25B 1/23

(57) ABSTRACT

Aspects of the present disclosure generally relate to catalyst compositions, processes for producing such catalyst compositions, and uses of such catalyst compositions. In an embodiment, a composition is provided. The composition includes an electrolyte material or an ion thereof, an amphiphile material or an ion thereof, and a metal component, the metal component comprising an alloy having the formula (M¹)ₐ(M²)_{b}, wherein M¹ is a Group 10-11 metal of the periodic table of the elements, M² is a first Group 8-11 metal of the periodic table of the elements, M¹ and M² are different, and a and b are positive numbers. In another embodiment, a device is provided that includes an electrolyte material or ion thereof, an amphiphile material or ion thereof, and a metal component disposed on an electrode, the metal component comprising a bimetallic nanoframe, a trimetallic nanoframe, or a combination thereof.

### CROSS-REFERENCE TO RELATED APPLICATIONS

This application claims benefit to U.S. Provisional Application No. 63/213,917, filed on Jun. 23, 2021, which is herein incorporated by reference in its entirety.

### FIELD

Aspects of the present disclosure generally relate to catalyst compositions, processes for producing such catalyst compositions, and uses of such catalyst compositions in, e.g., devices and processes for producing conversion products.

### BACKGROUND

Various metal catalysts are utilized in renewable energy technologies such as electrochemical water-splitting and carbon dioxide (CO₂) reduction reactions. Noble metals such as platinum are the most commonly used metal catalysts for such reactions. However, the high cost of noble metals limits their widespread adoption. Efforts have been made to replace, or reduce the amount of, these expensive metals with abundant metals such as copper and nickel, as well as transition metal dichalcogenides (TMDs). However, the use of Cu—Ni nanoparticles or TMDs in electrochemical oxygen reduction reactions, hydrogen evolution reactions, and other catalyst applications, remains a challenge because of, e.g., their low efficiency. For this reason among others, catalysts fabricated from relatively abundant metals do not represent a viable replacement for noble metal-based catalysts.

There is a need for new catalyst compositions that overcome the aforementioned deficiencies.

### SUMMARY

Aspects of the present disclosure generally relate to catalyst compositions, processes for producing such catalyst compositions, and uses of such catalyst compositions in, e.g., devices and processes for producing conversion products.

In an embodiment, a composition is provided. The composition includes an electrolyte material or an ion thereof, an amphiphile material or an ion thereof, and a metal component, the metal component comprising an alloy having the formula (M¹)ₐ(M²)_{b}, wherein: M′ is a Group 10-11 metal of the periodic table of the elements, M² is a first Group 8-11 metal of the periodic table of the elements, M¹ and M² are different, and a and b are positive numbers.

In another embodiment, a device is provided. The device includes an electrolyte material or ion thereof, an amphiphile material or ion thereof, and a metal component disposed on an electrode, the metal component comprising a bimetallic nanoframe, a trimetallic nanoframe, or a combination thereof.

In another embodiment, a process for converting water to a conversion product is provided. The process includes introducing an electrolyte material and an amphiphile material with a metal component to form a mixture comprising a catalyst composition, the metal component comprising a Group 10-11 metal and at least one Group 8-11 metal; and applying a voltage to the catalyst composition to form the conversion product.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1A is a non-limiting illustration of a nanocrystal according to at least one aspect of the present disclosure.

FIG. 1B is a non-limiting illustration of a hollow nanocrystal according to at least one aspect of the present disclosure.

FIG. 1C is an exemplary low resolution transmission electron microscopy (LRTEM) of an example nanocrystal according to at least one aspect of the present disclosure.

FIG. 1D is an exemplary LRTEM image of an example hollow nanoframe according to at least one aspect of the present disclosure.

FIG. 1E is an example reaction diagram for forming metallic nanoframes according to at least one aspect of the present disclosure.

FIG. 2A is an example reaction diagram for forming a bimetallic structure according to at least one aspect of the present disclosure.

FIG. 2B is an example reaction diagram for forming a Group 8-11 metal complex according to at least one aspect of the present disclosure.

FIG. 3A is a flowchart showing selected operations of an example process for producing a bimetallic structure according to at least one aspect of the present disclosure.

FIG. 3B is a flowchart showing selected operations of an example process for producing a bimetallic structure according to at least one aspect of the present disclosure.

FIG. 4 is an example reaction diagram for forming a trimetallic structure according to at least one aspect of the present disclosure.

FIG. 5A is a flowchart showing selected operations of an example process for producing a trimetallic structure according to at least one aspect of the present disclosure

FIG. 5B is a flowchart showing selected operations of an example process for producing a bimetallic structure according to at least one aspect of the present disclosure.

FIG. 6 is a side view of an example device for performing an hydrogen evolution reaction (HER) according to at least one aspect of the present disclosure.

FIG. 7 is an illustration of an example device 700 for performing HER according to at least one aspect of the present disclosure.

FIG. 8A is an exemplary scanning electron microscopy (SEM) image of example Cu—Ni—Pt polyhedral nanoparticles evolved from Cu—Ni rhombic dodecahedron nanoparticles according to at least one aspect of the present disclosure.

FIG. 8B is an exemplary high-angle annular dark field-scanning transmission electron microscopy (HAADF-STEM) image of example Cu—Ni—Pt polyhedral nanoparticles evolved from Cu—Ni rhombic dodecahedron nanoparticles according to at least one aspect of the present disclosure.

FIG. 8C is an exemplary EDS mapping image showing the Cu, Ni, and Pt portions of the example Cu—Ni—Pt polyhedral nanoparticles imaged in FIG. 8B.

FIG. 8D is an exemplary EDS mapping image showing the Cu portions of the example Cu—Ni—Pt polyhedral nanoparticles imaged in FIG. 8B.

FIG. 8E is an exemplary EDS mapping image showing the Ni portions of the example Cu—Ni—Pt polyhedral nanoparticles imaged in FIG. 8B.

FIG. 8F is an exemplary EDS mapping image showing the Pt portions of the example Cu—Ni—Pt polyhedral nanoparticles imaged in FIG. 8B.

FIG. 9 is an exemplary energy dispersive X-ray (EDX) spectrum of example Cu—Ni—Pt polyhedral nanoparticles according to at least one aspect of the present disclosure.

FIG. 10 is an exemplary X-ray diffraction (XRD) pattern of example Cu—Ni—Pt polyhedral nanoparticles and example Cu—Ni rhombic-hexagonal dodecahedron nanoparticles according to at least one aspect of the present disclosure.

### DETAILED DESCRIPTION

Aspects of the present disclosure generally relate to catalyst compositions, processes for producing such catalyst compositions, and uses of such catalyst compositions in, e.g., devices and processes for producing conversion products. The inventors have found catalyst compositions that are, e.g., noble-metal free or have a reduced content of noble metals, and that show enhanced electrocatalytic activity over conventional compositions. In some examples, the catalyst compositions include a metallic structure, such as nanoframe and/or a structure that is at least partially hollow, both of which having a high number of defects relative to crystalline nanoparticles. The catalyst compositions further include an electrolyte material and a molecular mediator material (e.g., amphiphile materials/compounds that are charged in solution). The electrolyte material and the molecular mediator material promote hydrogen coverage on the defect sites of the metallic structures, thereby, e.g., enhancing the catalytic activity in various conversion reactions. For example, the catalyst compositions of the present disclosure can also be employed as catalysts for various reactions, e.g., carbon dioxide reduction reactions, oxygen reduction reactions, hydrogen evolution reactions, and complicated organic reactions, such as annulation chemistry and aerobic dehydrogenation reactions.

### Catalyst Compositions

Aspects of the present disclosure generally relate to catalyst compositions. Such catalyst compositions can be useful for conversion reactions such as electrocatalytic conversion reactions. Illustrative, but non-limiting, examples of the electrocatalytic conversion reaction is the conversion of water into hydrogen via hydrogen evolution reactions and the reduction of CO₂ to useful products such as fuels and chemicals. According to some aspects, the catalyst compositions include three or more components.

The first component, also referred to as the metal component, includes a metallic structure such as a bimetallic structure and/or a trimetallic structure. These bimetallic and/or trimetallic structures can be complexes, alloys, compounds, coordination compounds, or the like. The second component and the third component, the electrolyte material and the molecular mediator material, respectively, are discussed below.

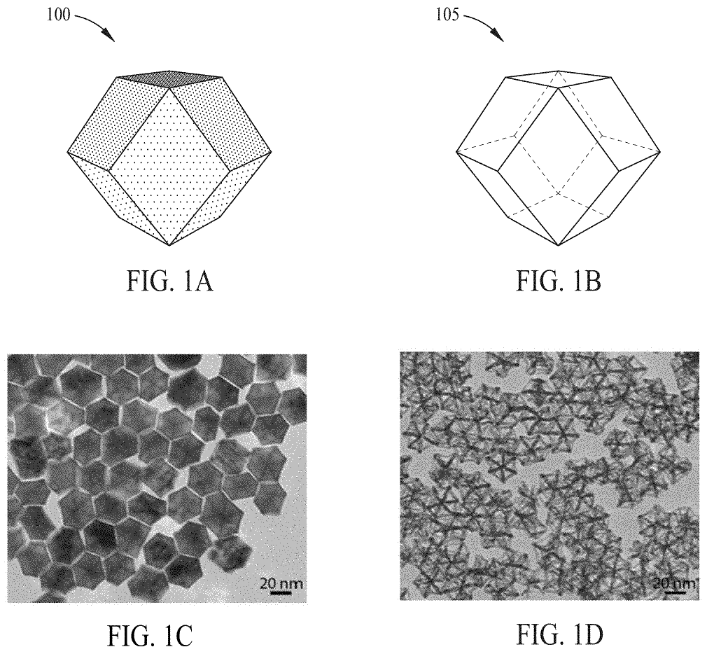

FIG. 1A shows an illustration of a dodecahedral nanocrystal 100 and FIG. 1B is an exemplary, non-limiting, illustration of a metallic structure in the form of a hollow dodecahedral nanocrystal 105 (or nanoframe). Such hollow, substantially hollow, or partially hollow nanocrystals are used in catalyst compositions described herein. It is contemplated that the metallic structure have other three-dimensional shapes (e.g., polyhedra, such as rhombic, cubic, cuboctahedral, etc.) with any suitable number of faces.

A nanoframe is a nanostructured material that includes a plurality of interconnected struts arranged to form the edges of a polyhedron, defining a partially hollow, substantially hollow, or hollow interior volume. An overall surface area to volume ratio (surface-to-volume ratio) of the nanoframe is greater than that of an identically shaped polyhedral particle having solid interior volume. Nanoframes are unique for their three-dimensional, highly open architecture. FIG. 1C and FIG. 1D show LRTEM images of an example nanocrystal and an example hollow nanocrystal (or nanoframe), respectively. The images illustrate, e.g., that nanoframes can be characterized as having disordered, defective, or otherwise irregular morphologies. The nanoframes described herein can be attractive for use as heterogeneous catalysts because of, e.g., their high density of catalytically-active sites and large specific surface areas. The high number of catalytically-active sites and large specific surface areas of the hollow nanocrystals relative to nanocrystals, is due to, e.g., the aforementioned defects. Due to such properties, lower catalyst loads with lower costs can be achieved in various conversion reactions.

The metallic structures used in the catalyst compositions can be in the form of homogeneous structures such as an alloy structure, as well as heterogeneous structures such as a core-shell structure, a core-shell-frame structure, and/or a heterostructure. Other metallic structures include intermetallic structures and partial alloys. Each of these different types of metallic structures can have different physical performance capabilities.

The metallic structure has a suitable concentration of “defects”. A “defect” refers to vacancies, stacking faults, grain boundary, edge dislocation, or other defects of the metallic structures described herein. The defect(s) can promote catalytic activity of the catalyst composition by, e.g., increasing the active sites and surface area to which protons can bond. The surface defects can be observed by HRTEM.

As discussed above, the metallic structure can be in the form of, e.g., a bimetallic structure. The bimetallic structure includes at least two metals. The first metal is a Group 10-11 metal of the periodic table of the elements, such as nickel (Ni), copper (Cu), palladium (Pd), platinum (Pt), silver (Ag), gold (Au), or combinations thereof, such as Ni, Cu, or a combination thereof. The second metal is a Group 8-11 metal of the periodic table of elements, such as iron (Fe), ruthenium (Ru), osmium (Os), cobalt (Co), rhodium (Rh), iridium (Ir), Ni, Pd, Pt, Cu, Ag, Au, or combinations thereof, such as Fe, Co, Ni, Pt, Pt, Cu, Ag, Au, or combinations thereof. The Group 10-11 metal is different from the Group 8-11 metal.

The bimetallic structures can also include one or more elements from Group 13-16 of the periodic table of the elements such as phosphorous, nitrogen, or a combination thereof. The one or more elements from Group 13-16, e.g., phosphorous atoms, nitrogen atoms, sulfur atoms, and/or oxygen atoms, can be in the form of ligand(s) and/or chelating group(s) bound to the Group 10-11 metal, the Group 8-11 metal, or both the Group 10-11 metal and the Group 8-11 metal. The ligand(s) and/or chelating group(s), when present, can be in the form of neutral species, monodentate species, bidentate species, and/or polydentate species.

In some aspects, the bimetallic structure has the formula (IA), formula (TB), or a combination thereof:

(M¹)ₐ(M²)_{b} (IA),

(M¹)ₐ(M²)_{b}(E¹)_{c}(E²)_{d} (IB)

wherein: M¹ is a Group 10-11 metal of the periodic table of the elements, such as Ni, Cu, Pd, Pt, Ag, Au, or combinations thereof, such as Ni, Cu, or a combination thereof;
M² is a Group 8-11 metal of the periodic table of the elements, such as Fe, Ru, Os, Co, Rh, Ir, Ni, Pd, Pt, Cu, Ag, Au, or combinations thereof, such as Fe, Co, Ni, Pt, Pt, Cu, Ag, Au, or combinations thereof;
M¹ and M² being different metals;
E¹ and E² are, independently, a Group 13-16 element such as P, N, O, or S, such as P or N;
a is the amount of M¹;
b is the amount of M²;
c is the amount of E′, and
d is the amount of E².

A molar ratio of a:b can be from about 1:99 to about 99:1, such as from about 10:90 to about 90:10, such as from about 20:80 to about 80:20, such as from about 30:70 to about 70:30, such as from about 40:60 to about 60:40, such as from about 45:55 to about 55:45, such as from about 48:52 to about 50:50. In some aspects, a molar ratio of a:b can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of a:b is from about 1:99 to about 20:1, such as from about 5:95 to about 10:1, such as from about 10:90 to about 1:1, such as from about 30:70 to about 40:60.

A molar ratio of a:c can be from about 1000:1 to about 100:1, such as from about 900:1 to about 200:1, such as from about 800:1 to about 300:1, such as from about 700:1 to about 400:1, such as from about 600:1 to about 500:1. In at least one aspect, a molar ratio of a:c is from about 50:1 to 1:1, such as from about 20:1 to about 3:1, such as from about 10:1 to about 5:1.

A molar ratio of a:d can be from about 500:1 to about 50:1, such as from about 450:1 to about 100:1, such as from about 400:1 to about 150:1, such as from about 350:1 to about 200:1, such as from about 300:1 to about 250:1. In at least one aspect, a molar ratio of a:d is from about 40:1 to 1:1, such as from about 20:1 to about 3:1, such as from about 10:1 to about 5:1.

A molar ratio of b:c can be from about 500:1 to about 50:1, such as from about 450:1 to about 100:1, such as from about 400:1 to about 150:1, such as from about 350:1 to about 200:1, such as from about 300:1 to about 250:1. In at least one aspect, a molar ratio of b:c is from about 40:1 to 1:1, such as from about 20:1 to about 3:1, such as from about 10:1 to about 5:1.

A molar ratio of b:d can be from about 150:1 to about 10:1, such as from about 125:1 to about 25:1, such as from about 100:1 to about 40:1, such as from about 90:1 to about 50:1, such as from about 80:1 to about 60:1, such as from about 75:1 to about 65:1. In at least one aspect, a molar ratio of b:d is from about 10:1 to 1:1, such as from about 8:1 to about 3:1, such as from about 7:1 to about 5:1.

A molar ratio of c:d can be from about 1:100 to about 1:20, such as from about 1:80 to about 1:30, from about 1:60 to about 1:45. In at least one aspect, a molar ratio of b:d is from about 1:20 to about 1:1, such as from about 1:10 to about 1:3, from about 1:6 to about 1:5.

A molar ratio of a:(c+d) can be from about 500:1 to about 1:1, such as from about 400:1 to about 20:1, such as from about 200:1 to about 50:1, such as from about 150:1 to about 80:1, such as from about 130:1 to about 90:1, such as from about 120:1 to about 95:1, such as from about 110:1 to about 105:1.

For the bimetallic structure of formula (IA) and/or formula (TB), the molar ratios of a:b, a:c, a:d, b:c, b:d, c:d, and a:(c+d) are determined by transmission electron microscopy of the bimetallic structure being analyzed.

For processes for producing a bimetallic structure of formula (IA) and/or formula (TB), the molar ratio of a:b, a:c, a:d, b:c, b:d, c:d, a:(c+d) of the bimetallic structure are determined based on the starting material molar ratio used for the synthesis.

In some aspects, the trimetallic structure includes at least three metals. One of the metals is a Group 10-11 metal, such as Ni, Cu, Pd, Pt, Ag, Au, or combinations thereof, such as Ni, Cu, or a combination thereof. The other two metals are a first Group 8-11 metal and a second Group 8-11 metal. The first Group 8-11 metal can include Fe, Ru, Os, Co, Rh, Ir, Ni, Pd, Pt, Cu, Ag, Au, or combinations thereof, such as Fe, Co, Ni, Pt, Pt, Cu, Ag, Au, or combinations thereof. The second Group 8-11 metal can include Fe, Ru, Os, Co, Rh, Ir, Ni, Pd, Pt, Cu, Ag, Au, or combinations thereof, such as Fe, Co, Ni, Pt, Pt, Cu, Ag, Au, or combinations thereof. Each of the three metals of the trimetallic structure are different.

The trimetallic structures can also include one or more elements from Group 13-16 of the periodic table of the elements such as phosphorous, nitrogen, or a combination thereof. The one or more elements from Group 13-16, e.g., phosphorous atoms, nitrogen atoms, sulfur atoms and/or oxygen atoms, can be in the form of ligand(s) and/or chelating group(s) bound to the Group 10-11 metal, the first Group 8-11 metal, the second Group 8-11 metal, or combinations thereof. The ligand(s) and/or chelating group(s), when present, can be in the form of neutral species, monodentate species, bidentate species, and/or polydentate species.

In some aspects, the trimetallic structure has the formula (IIA), formula (IB), or a combination thereof:

(M³)ₑ(M⁴)_{f}(M⁵)_{g} (IA)

(M³)ₑ(M⁴)_{f}(M⁵)_{g}(E³)ₕ(E⁴)ⱼ (IIB),

wherein:
M³ is a Group 10-11 metal of the periodic table of the elements, such as Ni, Cu, Pd, Pt, Ag, Au, or combinations thereof, such as Ni, Cu, or a combination thereof;
M⁴ is a Group 8-11 metal of the periodic table of the elements, such as Fe, Ru, Os, Co, Rh, Ir, Ni, Pd, Pt, Cu, Ag, Au, or combinations thereof, such as Fe, Co, Ni, Pt, Pt, Cu, Ag, Au, or combinations thereof;
M⁵ is a Group 8-11 metal of the periodic table of the elements, such as Fe, Ru, Os, Co, Rh, Ir, Ni, Pd, Pt, Cu, Ag, Au, or combinations thereof, such as Fe, Co, Ni, Pt, Pt, Cu, Ag, Au, or combinations thereof;
M³, M⁴, and M⁵ being different metals;
E³ and E⁴ are, independently, a Group 13-16 element such as P, N, O, or S, such as P or N;
e is the amount of M³;
f is the amount of M⁴;
g is the amount of M⁵;
h is the amount of E³;
j is the amount of E⁴.

A molar ratio of e:f can be from about 1:98 to about 98:1, such as from about 9:90 to about 90:9, such as from about 20:79 to about 79:20, such as from about 30:69 to about 69:30, such as from about 40:59 to about 59:40, such as from about 45:54 to about 54:45, such as from about 47:52 to about 50:49. In some aspects, a molar ratio of e:f can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of e:f is from about 1:98 to about 20:1, such as from about 4:95 to about 10:1, such as from about 9:90 to about 1:1, such as from about 29:70 to about 40:59.

A molar ratio of e:g can be from about 1:98 to about 98:1, such as from about 9:90 to about 90:9, such as from about 20:79 to about 79:20, such as from about 30:69 to about 69:30, such as from about 40:59 to about 59:40, such as from about 45:54 to about 54:45, such as from about 47:52 to about 50:49. In some aspects, a molar ratio of e:g can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of e:g is from about 1:98 to about 20:1, such as from about 4:95 to about 10:1, such as from about 9:90 to about 1:1, such as from about 29:70 to about 40:59.

A molar ratio of f:g can be from about 1:98 to about 98:1, such as from about 9:90 to about 90:9, such as from about 20:79 to about 79:20, such as from about 30:69 to about 69:30, such as from about 40:59 to about 59:40, such as from about 45:54 to about 54:45, such as from about 47:52 to about 50:49. In some aspects, a molar ratio of e:g can be from about 20:1 to about 1:20, such as from about 10:1 to about 1:10, such as from about 5:1 to about 1:5, such as from about 3:1 to about 1:3, such as from about 2:1 to about 1:2. In at least one aspect, a molar ratio of f:g is from about 1:98 to about 20:1, such as from about 4:95 to about 10:1, such as from about 9:90 to about 2:1, such as from about 29:70 to about 40:59.

A molar ratio of e:h can be from about 1:100 to about 50:1, such as from about 1:80 to about 60:1, such as from about 1:50 to about 70:1, such as from about 1:40 to about 80:1, such as from about 1:20 to about 90:1. In at least one aspect, a molar ratio of e:h is from about 1:20 to 80:1, such as from about 1:10 to about 50:1, such as from about 1:5 to about 10:1.

A molar ratio of e:j can be from about 1:200 to about 50:1, such as from about 1:180 to about 100:1, such as from about 1:150 to about 150:1, such as from about 1:100 to about 200:1, such as from about 1:80 to about 250:1. In at least one aspect, a molar ratio of e:j is from about 1:60 to 40:1, such as from about 1:30 to about 20:1, such as from about 1:10 to about 5:1.

A molar ratio of f:g can be from about 1:98 to about 98:1, such as from about 9:90 to about 90:9, such as from about 20:79 to about 79:20, such as from about 30:69 to about 69:30, such as from about 40:59 to about 59:40. In at least one aspect, a molar ratio f:g is from about 50:1 to about 1:50, such as from about 40:1 to about 1:40, such as from about 30:1 to about 1:30, such as from about 20:1 to about 1:20, such as from about 10:1 to about 1:10.

A molar ratio of f:h can be from about 50:1 to about 1:100, such as from about 40:1 to about 1:80, such as from about 30:1 to about 1:60, such as from about 20:1 to about 1:50, such as from about 15:1 to about 1:40. In at least one aspect, a molar ratio f:h is from about 10:1 to about 1:1, such as from about 8:1 to about 1:5, such as from about 6:1 to about 1:10, such as from about 5:1 to about 1:20.

A molar ratio of f:j can be from about 50:1 to about 1:500, such as from about 45:1 to about 1:400, such as from about 40:1 to about 1:350, such as from about 35:1 to about 1:200, such as from about 30:1 to about 1:100. In at least one aspect, a molar ratio f:j is from about 20:1 to about 1:50, such as from about 15:1 to about 1:40, such as from about 10:1 to about 1:30, such as from about 5:1 to about 1:10.

A molar ratio of g:h can be from about 1:100 to about 1:20, such as from about 1:80 to about 1:30, from about 1:60 to about 1:45. In at least one aspect, a molar ratio of g:h is from about 1:20 to about 1:1, such as from about 1:10 to about 1:3, from about 1:6 to about 1:5.

A molar ratio of g:j can be from about 50:1 to about 1:1000, such as from about 40:1 to about 1:500, such as from about 30:1 to about 1:300, such as from about 20:1 to about 1:200, such as from about 10:1 to about 1:100. In at least one aspect, a molar ratio g:j is from about 10:1 to about 1:50, such as from about 8:1 to about 1:30, such as from about 6:1 to about 1:20, such as from about 3:1 to about 1:10.

A molar ratio of e:(f+g) can be from about 1:99 to about 99:1, such as from about 10:90 to about 90:10, such as from about 20:80 to about 80:20, such as from about 30:70 to about 70:30, such as from about 40:60 to about 60:40. In at least one aspect, a molar ratio f:g is from about 50:1 to about 1:50, such as from about 40:1 to about 1:40, such as from about 30:1 to about 1:30, such as from about 20:1 to about 1:20, such as from about 10:1 to about 1:10.

A molar ratio of e:(h+j) can be from about 50:1 to about 1:300, such as from about 40:1 to about 1:200, such as from about 20:1 to about 1:100, such as from about 10:1 to about 1:50, such as from about 8:1 to about 1:20, such as from about 5:1 to about 1:10, such as from about 1:1 to about 1:5.

A molar ratio of f:(h+j) can be from about 50:1 to about 1:600, such as from about 40:1 to about 1:400, such as from about 20:1 to about 1:100, such as from about 10:1 to about 1:50, such as from about 8:1 to about 1:20, such as from about 5:1 to about 1:10, such as from about 1:1 to about 1:5.

A molar ratio of g:(h+j) can be from about 50:1 to about 1:1000, such as from about 40:1 to about 1:800, such as from about 20:1 to about 1:500, such as from about 10:1 to about 1:200, such as from about 8:1 to about 1:80, such as from about 5:1 to about 1:20, such as from about 1:1 to about 1:5.

For the trimetallic structures of formula (IIA) and formula (IIB), the molar ratios of e:f, e:g, e:h, e:j, f:g, f:h, f:j, g:h, g:j, h:j, e:(f+g), e:(h+j), f:(h+j), and g:(h+j) are determined by transmission electron microscopy of the trimetallic structure being analyzed.

For processes for producing the trimetallic structures of formula (IIA) and formula (IIB), the molar ratio of e:f, e:g, e:h, e:j, f:g, g:h, g:j, h:j, e:(f+g), e:(h+j), f:(h+j), and g:(h+j) of the trimetallic structure are determined based on the starting material molar ratio used for the synthesis.

The phosphorous of the metallic structures described herein, e.g., the bimetallic structure of formula (IB) and the trimetallic structure of formula (IIB), originates from a phosphorous-containing compound utilized for the synthesis of the metallic structure. Such phosphorous-containing compounds include phosphines having the formula

PR¹R²R³,

wherein:
each of R¹, R², and R³ is independently selected from hydrogen, unsubstituted hydrocarbyl, substituted hydrocarbyl, unsubstituted aryl, substituted aryl, or two or more of R¹, R² and/or R³ may join together to form a substituted or unsubstituted, cyclic or polycyclic ring structure. Unsubstituted hydrocarbyl includes C₁-C₁₀₀ unsubstituted hydrocarbyl, such as C₁-C₄₀ unsubstituted hydrocarbyl, such as C₁-C₂₀ unsubstituted hydrocarbyl, such as C₁-C₁₀ unsubstituted hydrocarbyl, such as C₁-C₆ unsubstituted hydrocarbyl. Substituted hydrocarbyl includes C₁-C₁₀₀ substituted hydrocarbyl, such as C₁-C₄₀ substituted hydrocarbyl, such as C₁-C₂₀ substituted hydrocarbyl, such as C₁-C₁₀ substituted hydrocarbyl, such as C₁-C₆ substituted hydrocarbyl. Unsubstituted aryl includes C₄-C₁₀₀ unsubstituted aryl, such as C₄-C₄₀ unsubstituted aryl, such as C₄-C₂₀ unsubstituted aryl, such as C₄-C₁₀ unsubstituted aryl. Substituted aryl includes C₄-C₁₀₀ substituted aryl, such as a C₄-C₄₀ substituted aryl, such as C₄-C₂₀ substituted aryl, such as C₄-C₁₀.

Each of R¹, R², and R³ is, independently, saturated or unsaturated, linear or branched, cyclic or acyclic, aromatic or non-aromatic. When one or more of R², and/or R³ is joined together, the formed structure may be substituted or unsubstituted, fully saturated, partially unsaturated, or fully unsaturated, aromatic or non-aromatic, cyclic or polycyclic.

For the purposes of this present disclosure, and unless otherwise specified, the terms “hydrocarbyl radical,” “hydrocarbyl group,” or “hydrocarbyl” interchangeably refer to a group consisting of hydrogen and carbon atoms only. A hydrocarbyl group can be saturated or unsaturated, linear or branched, cyclic or acyclic, aromatic, or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and aryl groups, such as phenyl, benzyl, naphthyl.

For the purposes of this present disclosure, and unless otherwise specified, the term “aryl” or “aryl group” interchangeably refers to a hydrocarbyl group comprising an aromatic ring structure therein.

“Hydrocarbyl”, “aryl”, “substituted hydrocarbyl”, and “substituted aryl” are described above. “Substituted alkenyl” refers to an alkenyl, where at least one hydrogen of the alkenyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like or where at least one heteroatom has been inserted within the alkenyl radical such as one or more of halogen (Cl, Br, I, F), O, N, S, Se, Te, NR*, PR*, AsR*, SbR*, BR*, SiR*₂, GeR*₂, SnR*₂, PbR*₂, and the like, where R* is, independently, hydrogen, hydrocarbyl (e.g., C₁-C₁₀), or two or more R* may join together to form a substituted or unsubstituted completely saturated, partially unsaturated, fully unsaturated, or aromatic cyclic or polycyclic ring structure.

In at least one aspect, one or more of R¹, R², or R³ is, independently, methyl, ethyl, n-propyl, isopropyl, n-butyl, isobutyl, tert-butyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl, cyclopentyl, cyclohexyl, phenyl, benzyl, isomers thereof, or derivatives thereof.

Illustrative, but non-limiting, examples of phosphorous-containing compounds include alkylphosphines and/or arylphosphines such as trimethylphosphine, triethylphosphine, tripropylphosphine, tributylphosphine, tripentylphosphine, trihexylphosphine, trioctylphosphine, tricyclohexylphosphine, di ethylphosphine, dibutylphosphine, diphenylphosphine, dimethylethylphosphine, triphenylphosphine, isomers thereof, derivatives thereof, and combinations thereof.

The nitrogen of the metallic structures described herein, e.g., the bimetallic structure of formula (IB) and the trimetallic structure of formula (IIB), structure originates from a nitrogen-containing compound utilized for the synthesis of the metallic structure. Such nitrogen-containing compounds include, e.g., primary amines, secondary amines, tertiary amines, or combinations thereof. The nitrogen-containing compounds can include an unsubstituted hydrocarbyl or a substituted hydrocarbyl (as described herein) bonded to the nitrogen of the nitrogen-containing compound, where the unsubstituted hydrocarbyl or substituted hydrocarbyl can be saturated or unsaturated, linear or branched, cyclic or acyclic, aromatic or non-aromatic. The nitrogen-containing compound can be an alkylamine. Illustrative, but non-limiting, examples of nitrogen-containing compounds include oleylamine (OLA), octadecylamine (ODA), hexadecylamine (HDA), dodecylamine (DDA), tetradecylamine (TDA), isomers thereof, derivatives thereof, or combinations thereof.

In some aspects, a sulfur of the metallic structures described herein, e.g., the bimetallic structure of formula (IB) and the trimetallic structure of formula (IIB), originates from a sulfur-containing compound utilized for the synthesis of the metallic structure. Such sulfur-containing compounds include C₁-C₁₀₀ hydrocarbyls substituted with at least one sulfur atom, such as C₁-C₁₀₀ thiols, C₁-C₄₀ thiols, such as C₁-C₂₀ thiols, such as C₁-C₁₀ thiols, such as C₁-C₆ thiols. The sulfur-containing compounds can be saturated or unsaturated, linear or branched, cyclic or acyclic, aromatic or non-aromatic.

In some aspects, an oxygen of the metallic structures described herein, e.g., the bimetallic structure of formula (IB) and the trimetallic structure of formula (IIB), originates from an oxygen-containing compound utilized for the synthesis of the metallic structure. Such oxygen-containing compounds include C₁-C₁₀₀ (such as C₁-C₄₀, such as C₁-C₂₀, such as C₁-C₁₀, such as C₁-C₆) hydrocarbyls substituted with at least one oxygen atom. The oxygen-containing compounds can be saturated or unsaturated, linear or branched, cyclic or acyclic, aromatic or non-aromatic. A non-limiting example of oxygen containing compounds includes fatty acids.

In some aspects, the metallic structure can have an average particle size from about 5 nm to about 2000 μm, such as from about from 50 nm to 200 μm, such as from about from 50 nm to 20 μm, such as from about from 500 nm to 2 μm. For polyhedral particles (e.g., metallic structures described herein), the average particle size is an equivalent edge length as measured by TEM. In some examples, the average particle size can be about 5 nm or more, such as from about 10 nm to about 100 nm, such as from about 15 nm to about 95 nm, 20 nm to about 90 nm, such as from about 25 nm to about 85 nm, such as from about 30 nm to about 80 nm, such as from about 35 nm to about 75 nm, such as from about 40 nm to about 70 nm, such as from about 45 nm to about 65 nm, such as from about 50 nm to about 60 nm, such as from about 50 nm to about 60 nm, such as from about 50 nm to about 55 nm or from about 55 nm to about 60 nm. In some examples, the average particle size can be from about 10 nm to about 400 nm, such as from about 25 nm to about 375 nm, such as from about 50 nm to about 350 nm, such as from about 75 nm to about 325 nm, such as from about 100 nm to about 300 nm, such as from about 125 nm to about 275 nm, such as from about 150 nm to about 250 nm, such as from about 175 nm to about 225 nm, such as from about 175 nm to about 200 nm or from about 200 nm to about 225 nm.

The metallic structure can have an average edge length from about 800 nm to about 50 nm, such as from about 600 nm to about 100 nm, such as from about 400 nm to about 150 nm, such as from about 300 nm to about 200 nm, as determined by TEM. In at least one aspect, the average edge length is from about 3 nm to about 40 nm, such as from about 5 nm to about 30 nm, such as from about 10 nm to about 20 nm.

The metallic structure can have an average edge thickness from about 100 nm to about 5 nm, such as from about 80 nm to about 10 nm, such as from about 60 nm to about 20 nm, such as from about 40 nm to about 30 nm, as determined by TEM. In at least one aspect, the average edge thickness is less than about 5 nm, such as less than about 4 nm, such as less than about 3 nm, such as less than about 2 nm, such as less than about 1 nm.

The metallic structures can include particles and/or crystals that have various three-dimensional shapes (e.g., polyhedra) with a desired number of faces or sides. The number of sides can be in multiples of six starting with about 4 sides, and/or in multiples of eight starting with about 8 faces. The number of sides can be about 6, about 8, about 10, about 12, about 16, about 18, about 20, about 24, about 30, about 40, about 80, about 120, about 150, or about 180 sides.

As discussed above, the metallic structures can be at least at least partially hollow, substantially hollow, or hollow as determined by HAADF-STEM. The metallic structure can be characterized as a nanoframe as determined by HAADF-STEM. Although aspects detailed herein are related to nanoscale materials (e.g., nanoparticles, nanocrystals, and nanoframes), larger or smaller structures are contemplated such as microparticles, macroparticles, microcrystals, macrocrystals, microframes, and/or macroframes.

In some aspects, the metallic structure has an X-ray diffraction pattern showing peaks at {111}, {200}, {220}, and/or {311}. The metallic structures can be face-centered cubic, though other morphologies are contemplated.

The second component of the catalyst composition includes one or more electrolytes. The one or more electrolytes can include acids, such as acids having a pKa of about 3 or less, such as from about ˜8 to about 3, such as from about ˜5 to about 2, such as from about ˜3 to about 1, such as from about ˜2 to about 0. Illustrative, but non-limiting, examples of electrolytes include sulfuric acid (H₂SO₄, pKa of ˜3), nitric acid (HNO₃, pKa of ˜1.32), phosphoric acid (H₃PO₄, pKa of 2.16), hydrochloric acid (HCl, pKa of ˜3), hydroiodic acid (HI, pKa of ˜8), hydrobromic acid (HBr, pKa of ˜8), mixtures and/or combinations thereof, in any suitable proportions. The pKa is determined by potentiometric titration.

The third component of the catalyst composition includes one or more “molecular mediator” materials. The one or more molecular mediator materials can be one or more amphiphile materials. Amphiphile materials (or amphiphile compounds) include, but are not limited, to anionic surfactants, such as carboxylic acid-based surfactants, sulfate-based surfactants, and sulfonate based surfactants.

In some aspects, the amphiphile material or amphiphile compound can have a hydrophobic tail and a hydrophilic tail. The amphiphile material or amphiphile compound can have the formula

X—Y⁻Z⁺,X—Y⁻, or a combination thereof,

wherein:
X is unsubstituted hydrocarbyl, substituted hydrocarbyl, unsubstituted alkenyl, substituted alkenyl, unsubstituted aryl, substituted aryl, or combinations thereof;
Y⁻ is an anionic group such as

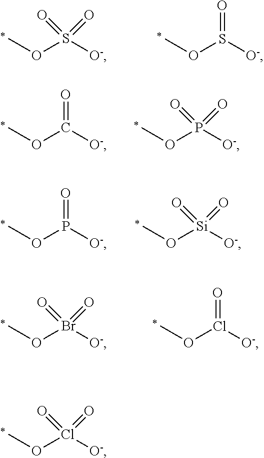

or combinations thereof, where “*” represents X; and
Z⁺ is a cation, such as a quaternary nitrogen (e.g., ammonium ion, NH₄⁺) and/or a metal such as Li, Na, K, Rb, Cs, Mg, Ca, Al, or combinations thereof.

For Y⁻, the anionic group can be bonded to a hydrogen, when for example, the amphiphile material or amphiphile compound is in solution.

For X, unsubstituted hydrocarbyl includes C₁-C₁₀₀ unsubstituted hydrocarbyl, such as C₁-C₄₀ unsubstituted hydrocarbyl, such as C₁-C₂₀ unsubstituted hydrocarbyl, such as C₁-C₁₀ unsubstituted hydrocarbyl, such as C₁-C₆ unsubstituted hydrocarbyl; substituted hydrocarbyl includes C₁-C₁₀₀ substituted hydrocarbyl, such as C₁-C₄₀ substituted hydrocarbyl, such as C₁-C₂₀ substituted hydrocarbyl, such as C₁-C₁₀ substituted hydrocarbyl, such as C₁-C₆ substituted hydrocarbyl; unsubstituted alkenyl includes C₁-C₁₀₀ unsubstituted alkenyl, such as C₁-C₄₀ unsubstituted alkenyl, such as C₁-C₂₀ unsubstituted alkenyl, such as C₁-C₁₀ unsubstituted alkenyl, such as C₁-C₆ unsubstituted alkenyl; substituted alkenyl includes C₁-C₁₀₀ substituted alkenyl, such as C₁-C₄₀ substituted alkenyl, such as C₁-C₂₀ substituted alkenyl, such as C₁-C₁₀ substituted alkenyl, such as C₁-C₆ substituted alkenyl; unsubstituted aryl includes C₄-C₁₀₀ unsubstituted aryl, such as C₄-C₄₀ unsubstituted aryl, such as C₄-C₂₀ unsubstituted aryl, such as C₄-C₁₀ unsubstituted aryl; and substituted aryl includes C₄-C₁₀₀ substituted aryl, such as a C₄-C₄₀ substituted aryl, such as C₄-C₂₀ substituted aryl, such as C₄-C₁₀.

For the purposes of this present disclosure, and unless otherwise specified, the term “alkenyl” or “alkenyl group” interchangeably refers to a linear unsaturated hydrocarbyl group comprising a C═C bond therein.

X can be saturated or unsaturated, linear or branched, cyclic or acyclic, aromatic or non-aromatic. In at least one aspect, X is a substituted or unsubstituted methyl, ethyl, ethenyl and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, propenyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, tricosenyl, tetracosenyl, pentacosenyl, hexacosenyl, heptacosenyl, octacosenyl, nonacosenyl, triacontenyl, isomers thereof, or derivatives thereof.

Illustrative, but non-limiting, examples of amphiphile materials (or amphiphile compounds) sodium dodecyl sulfate (SDS; C₁₂H₂₅NaSO₄), sodium oleate, sodium dodecyl phosphate, sodium 2-carboxyl dodecyl sulfate, sodium stearate, sodium lauroyl sarcosinate, cholic acid, deoxycholic acid, gylocylic acid-containing materials (e.g., glycolic acid ethoxylate 4-tert-butylphenyl ether, glycolic acid ethoxylate laurylphenyl ether, and glycolic acid ethoxylate oleyl ether), zonyl fluorosurfactant, ammonium dodecyl sulfate, dioctyl sodium sulfosuccinate, sodium dodecylbenzesulfonate, sodium lauryl sulfate, sodium lauryl ether sulfate, 3-sulfopropyl ethoxylate laurylphenyl ether, perfluorooctanesulfonic acid, perfluorobutane sulfonic acid, mixtures and/or combinations thereof, in any suitable proportions.

In solution, the amphiphile material or amphiphile compound can exist as ions, e.g., an anion and a cation, and/or its protonated form. The electrolyte material can also exist as an ion in solution.

The amphiphile material/amphiphile compound can be chosen from materials whose conjugate acid has a pKa that is about ˜8 to about 10, such as from about ˜5 to about 5, such as from about ˜2 to about 4, such as from about ˜1.7 to about 3, such as from about ˜1 to about 1. The pKa is determined by potentiometric titration.

In some aspects, the first component (i.e., the metal component) of the catalyst composition is in the form of a monolayer film or a film including multiple layers, e.g., such as about 10 or fewer layers, such as about 5 or fewer layers. Additionally, or alternatively, the first component is in the form of particles. In at least one aspect, the second component is in the form of an aqueous solution and/or the third component is in the form of an aqueous solution. The first component, second component, and the third component can be in the form of a suspension.

In at least one aspect, the first component, the second component, third component, or combinations thereof can facilitate conversion reactions. As described above, the second component and the third component enhance the catalytic activity of first component by, e.g., promoting hydrogen coverage at defect sites in the metallic structure.

The concentration of the electrolyte material (in solution) that is added to form the catalyst composition can be about 0.01 molar (M) or more, such as from about 0.05 M to about 0.5 M, such as from about 0.1 M to about 0.45 M, such as from about 0.15 to about 0.4 M, such as from about 0.2 M to about 0.35 M, such as from about 0.25 to about 0.3 M.

The concentration of the amphiphile material (in solution) that is added to form the catalyst composition can be about 0.05 millimolar (mM) or more, such as from about 0.1 mM to about 50 mM, such as from about 0.5 mM to about 45 mM, such as from about 1 mM to about 40 mM, such as from about 5 mM to about 35 mM, such as from about 10 mM to about 30 mM, such as from about 15 mM to about 25 mM.

A mass ratio of the nanoframes (the metal component) to the electrolyte material can be from about 5×10⁶:1 to about 10:1, such as from about 5×10⁵:1 to about 50:1, such as from about 5×10³:1 to about 1×10²:1, such as from about 1×10³:1 to about 2×10²:1. In at least one aspect, the mass ratio of the nanoframes (the metal component) to the electrolyte material can be from about 1000:1 to about 500:1, such as from about 900:1 to about 550:1, such as from about 850:1 to about 600:1, such as from about 700:1 to about 650:1.

The mass ratio of the nanoframes (the metal component) to the amphiphile material can be from about 1:100 to about 1:1×10⁵, such as from about 1:200 to about 1:10,000, such as from about 1:400 to about 1:1,000, such as from about 1:550 to about 1:800. In at least one aspect, the mass ratio of the nanoframes (the metal component) to the electrolyte material can be from about 1:600 to about 1:780, such as from about 1:620 to about 1:750, such as from about 1:650 to about 1:720, such as from about 1:670 to about 1:700.

### Processes for Forming Metallic Structures

The present disclosure also relates to processes for forming a metallic structure, e.g., a metallic nanoframe. The metallic structure is at least a portion of the metal component. FIG. 1E shows a general reaction diagram 120 for forming metallic nanoframes according to at least one aspect of the present disclosure. In this non-limiting illustration, a bimetallic structure 125, such as a polyhedral nanoparticle such as a Cu—Ni polyhedral nanoparticle, is reacted with a Group 10-11 metal complex 135 (Mⁿ⁺) and/or an acid 136 under conditions effective to form the metallic nanoframe 130. Illustrative, but non-limiting, examples of the Group 10-11 metal of the Group 10-11 metal complex 135 include Pt, Pd, Au, and/or Ag in suitable oxidation states such as Pt²⁺, Pd²⁺, Au³⁺, and/or Ag⁺. Illustrative, but non-limiting, examples of the metallic nanoframe 130 include bimetallic nanoframes (e.g., Ni-M, Cu-M), trimetallic nanoframes (e.g., Ni—Cu-M), or combinations of bimetallic and trimetallic nanoframes, where M is a Group 10-11 metal.

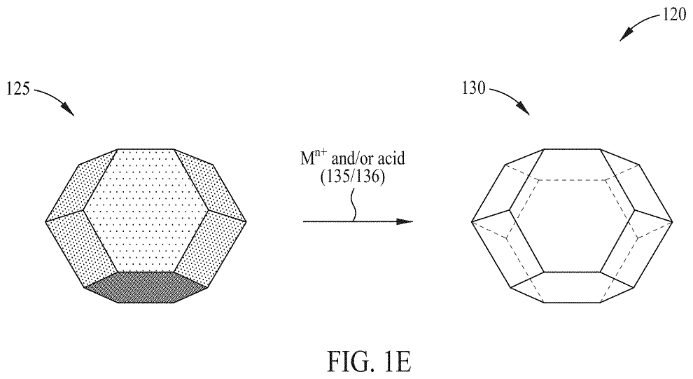

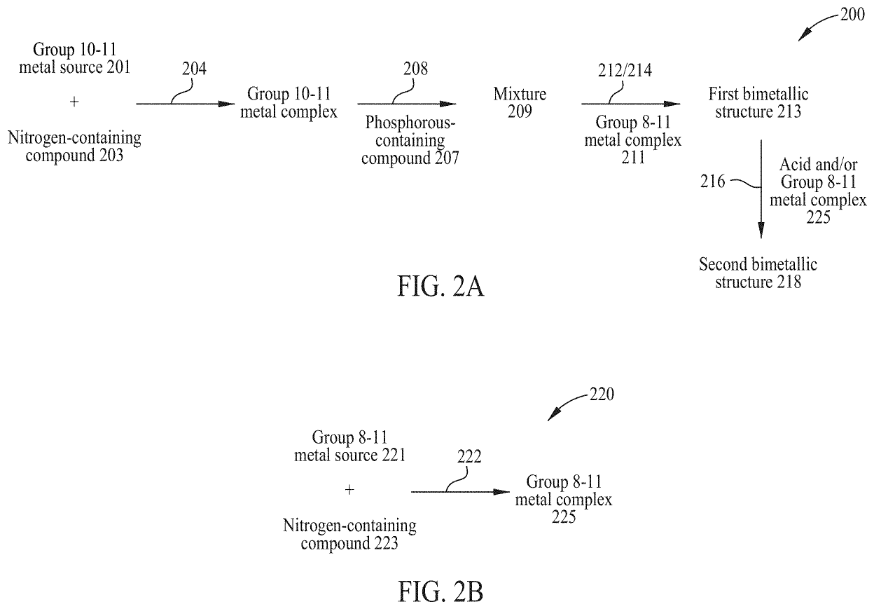

FIGS. 2A and 2B show reaction diagrams 200 and 220, respectively, illustrating selected operations for forming a bimetallic structure. The bimetallic structure can be at least partially hollow, substantially hollow, or hollow and/or characterized as a nanoframe, such as those described above. FIG. 3A is a flowchart showing selected operations of an example process 300 for producing the bimetallic structure according to at least one aspect of the present disclosure.

The process 300 includes forming a mixture 209, under first conditions, comprising a first precursor and a second precursor at operation 310. The first precursor includes a Group 10-11 metal and the second precursor includes a phosphorous-containing compound. The Group 10-11 metal of the first precursor can be in the form of a Group 10-11 metal complex 205.

The Group 10-11 metal complex 205 of the first precursor can be made by, e.g., introducing a Group 10-11 metal source 201 with a nitrogen-containing compound 203 under conditions 204 effective to form the Group 10-11 metal complex 205. The Group 10-11 metal complex 205 can be, e.g., a copper amine or a nickel amine. The Group 10-11 metal source 201 can include one or more ligands such as halide (e.g., I⁺, Br⁺, Cl⁻, or F⁻), acetylacetonate (O₂C₅H₇), hydride (H⁻), SCN⁻, NO₂⁺, NO₃⁻, N₃⁻, OH⁻, oxalate (C₂O₄²⁻, H₂O, acetate (CH₃COO⁺), O₂⁻, CN⁻, OCN⁻, OCN⁻, CNO⁻, NH₂⁻, NH²⁻, NC⁻, NCS⁻, N(CN)₂⁻, pyridine (py), ethylenediamine (en), 2,2′-bipyridine (bipy), PPh₃, or combinations thereof. In some aspects, the Group 10-11 metal of the Group 10-11 metal source 201 includes copper and/or nickel. Illustrative, but non-limiting, examples of the Group 10-11 metal source 201 include copper acetates, copper halides, copper nitrates, other suitable copper species, nickel acetates, nickel halides, nickel nitrates, and/or other suitable nickel species.

The nitrogen-containing compound 203 can be those described above. Illustrative, but non-limiting, examples of the nitrogen-containing compound 203 include OLA, ODA, HDA, DDA, TDA, or combinations thereof. The nitrogen-containing compound 203 can be utilized as a solvent. When desired, a solvent such as octadecene, phenyl ether, benzyl ether, or combinations thereof can additionally, or alternatively, be used. In some examples, the molar ratio of copper source to nitrogen-containing compound is from about 1:1000 to about 1:1, such as from about 1:500 to about 1:1, such as from about 1:100 to about 1:1, such as from about 1:50 to about 1:1 based on the starting material molar ratio used for the reaction. In some aspects, the molar ratio of copper source to nitrogen-containing compound is from about 1:20 to about 1:1, such as from about 1:10 to about 1:1, such as from about 1:4 to about 1:1, such as from about 1:2 to about 1:1 based on the starting material molar ratio used for the reaction.

Conditions 204 effective to form the Group 10-11 metal complex 205 (e.g., the copper amine or nickel amine) can include a reaction temperature and a reaction time. The reaction temperature to form the Group 10-11 metal complex 205 can be greater than about 40° C., such as greater than about 60° C., such as greater than about 80° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the reaction temperature to form the Group 10-11 metal complex 205 can be from about 150° C. to about 250° C. or from about 180° C. to about 240° C. Higher or lower temperatures can be used when appropriate. The reaction time to form the Group 10-11 metal complex 205 can be about 1 minute (min) or more or about 24 h or less, such as from about 1 min to about 12 h, such as from about 5 min to about 6 hours (h), such as from about 10 min to about 5.5 h, such as from about 15 min to about 5 h, such as from about 30 min to about 4 h, such as from about 45 min to about 3 h, such as from about 1 h to about 2 h. The reaction time to form the Group 10-11 metal complex 205 can be more or less depending on, e.g., the level of conversion desired. Any reasonable pressure can be used during formation of the Group 10-11 metal complex 205.

Conditions 204 effective to form the Group 10-11 metal complex 205 (e.g., the copper amine or nickel amine) can include stirring, mixing, and/or agitation. Conditions 204 effective to form the Group 10-11 metal complex 205 can optionally include utilizing a non-reactive gas, such as N₂ and/or Ar. For example, a mixture of the Group 10-11 metal source 201 and the nitrogen-containing compound 203 can be placed under these or other non-reactive gases to, e.g., degas various components or otherwise remove oxygen from the reaction mixture.

In some aspects, the Group 10-11 metal complex 205 can be kept in the form of a stock solution/suspension for use in operation 310. In other aspects, the reaction product comprising the Group 10-11 metal complex 205 can be subjected to filtration, separation, cleaning, quenching, washing, purification, and/or other suitable processes to remove undesired components and isolate the Group 10-11 metal complex 205 from the other components of the reaction mixture. For example, the reaction product comprising the Group 10-11 metal complex 205 (which may be in the form of particles) can be centrifuged to separate the Group 10-11 metal complex 205 from the mixture. Additionally, or alternatively, the Group 10-11 metal complex 205 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the Group 10-11 metal complex 205 from other components in the reaction mixture. As an example, a solvent or a mixture of solvents can be added to the Group 10-11 metal complex 205 and the resultant mixture centrifuged. The supernatant can be discarded and the remaining pellet can be dispersed in a suitable solvent or mixture of solvents. The resultant pellet and solvent(s) can then be centrifuged to obtain the Group 10-11 metal complex 205. In these and other aspects, the pellet comprising the Group 10-11 metal complex 205 can be re-solubilized or re-suspended in a nitrogen-containing compound such as those described above.

The second precursor of operation 310 includes a phosphorous-containing compound 207. The phosphorous-containing compound 207 can be one or more of those described above.

The first conditions of operation 310 can include an operating temperature and a duration of time. In FIG. 2A, the first conditions are designated by numeral 208. The operating temperature of operation 310 can be set to about 400° C. or less, such as from about 50° C. to about 400° C., such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C. In some aspects, the operating temperature of operation 310 can be set to a temperature of about 100° C. to about 150° C. or from about 180° C. to about 320° C. Higher or lower temperatures can be used when appropriate. The time for forming the mixture (e.g., the first conditions 208) of operation 310 can be about 1 min or more or about 24 h or less, such as from about 5 min to about 6 h, such as from about 10 min to about 1 h, though greater or lesser periods of time are contemplated. Operation 310 can include stirring, mixing, and/or agitating the mixture to ensure, e.g., homogeneity of the mixture. Operation 310 can be performed using a non-reactive gas (e.g., N₂ and/or Ar) to, e.g., remove or substantially remove oxygen from the mixing environment. Suitable operating pressures can be utilized for operation 310.

Additionally, the molar ratio of the first precursor (e.g., the Group 10-11 metal complex 205) to second precursor (e.g., the phosphorous-containing compound 207) can be adjusted as desired. In some examples, the molar ratio of the Group 10-11 metal complex 205 to the phosphorous-containing compound 207 is from about 50:1 to about 1:100, such as from about 20:1 to about 1:50, such as from about 10:1 to about 1:10 based on the starting material molar ratio used for the reaction. In some aspects, the molar ratio of the Group 10-11 metal complex 205 to the phosphorous-containing compound 207 is from about 5:1 to about 1:5, such as from about 3:1 to about 1:3, such as from about 1:1 to about 1:2 based on the starting material molar ratio used for the reaction.

In some aspects, and prior to introducing the first precursor with the second precursor, the second precursor can be mixed with a solvent. The solvent can be, or include, a nitrogen-containing compound, such as those described above. Additionally, or alternatively, other suitable solvents can be used. The solvent(s) and the second precursor, e.g., the phosphorous-containing compound 207, can be heated under a non-reactive gas (e.g., N₂ and/or Ar) at a temperature of about 50° C. or more to about 400° C. or less, such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C., for a suitable time such as about 24 h or less, such as about 12 h or less, such as about 5 h or less, such as about 1 h or less, such as about 30 min or less, such as about 10 min or less and under suitable pressures. In these and other aspects, the first precursor is then added to the second precursor and optional solvent. The resulting mixture can then be cooled to those temperatures of the first conditions described above, such as from about 50° C. to about 400° C., such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C. for a suitable time (described above), under suitable pressures, and optionally under a non-reactive gas (e.g., N₂ and/or Ar).

The process 300 further includes introducing, under second conditions, a third precursor with the mixture 209 to form a first bimetallic structure 213 at operation 320. The third precursor includes a Group 8-11 metal complex 211. The first bimetallic structure 213 formed in operation 320 can have the formula (M¹)ₐ(M²)_{b}(P)_{c}(N)_{d} as described above. In FIG. 2A, the second conditions are designated by numeral 212/214.

For operation 320, amounts of the Group 8-11 metal complex 211 of the third precursor can be adjusted relative to one or more components of the mixture formed in operation 310, e.g., the Group 10-11 metal complex 205 and the phosphorous-containing compound 207. For example, the molar ratio of Group 8-11 metal complex 211 to the phosphorous-containing compound 107 can be from about 1:500 to about 1:50, such as from about 1:250 to about 1:70, such as from about 1:120 to about 1:100 based on the starting material molar ratio used for the reaction. In some aspects, the molar ratio of Group 8-11 metal complex 211 to the phosphorous-containing compound 207 can be from about 1:50 to about 1:1, such as from about 1:20 to about 1:5, such as from about 1:10 to about 1:8 based on the starting material molar ratio used for the reaction.

Additionally, or alternatively, the molar ratio of the Group 8-11 metal complex 211 to the Group 10-11 metal complex 205 can be from about 100:1 to about 1:10, such as from about 80:1 to about 1:20, such as from about 50:1 to about 1:30 based on the starting material molar ratio used for the reaction. In some aspects, the molar ratio of the Group 8-11 metal complex 211 to the Group 10-11 metal complex 205 can be from about 1:1 to about 1:10, such as from about 1:2 to about 1:7, such as from about 1:3 to about 1:4 based on the starting material molar ratio used for the reaction.

When desired, a solvent such as octadecene, benzyl ether, phenyl ether, or combinations thereof can be used for operation 320. In some aspects, the third precursor comprising the Group 8-11 metal complex 211 is introduced to the mixture 209 as a solution/suspension in a solvent. For example, a nitrogen-containing compound, such as those described above, can be utilized as a solvent.

As shown in FIG. 2B, the Group 8-11 metal complex 211 of the third precursor can be formed by introducing a Group 8-11 metal source 221 with a nitrogen-containing compound 223 under conditions 222 effective to form the Group 8-11 metal complex 211 (or Group 8-11 metal complex 225 discussed below). The nitrogen-containing compound 223 can be the same or different than the nitrogen-containing compound 103. The Group 8-11 metal source 221 includes a Group 8-11 metal of the periodic table of the elements, such as Fe, Ru, Os, Co, Rh, Ir, Ni, Pd, Pt, Cu, Ag, Au, or combinations thereof, such as Fe, Co, Ni, Pt, Pt, Cu, Ag, Au, or combinations thereof. The Group 8-11 metal source 221 can also include one or more ligands such as halide (e.g., I⁻, Br⁻, Cl⁻, or F⁻), acetylacetonate (O₂C₅H₇), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁺, NH²⁻, NC⁻, NCS⁻, N(CN)₂⁻, pyridine (py), ethylenediamine (en), 2,2′-bipyridine (bipy), PPh₃, or combinations thereof. In some aspects, the Group 8-11 metal source 221 includes metal acetates, metal acetalacetonates, metal halides, metal nitrates, and/or other Group 8-11 metal species. Illustrative, but non-limiting, examples of the Group 8-11 metal source 221 include hexachloroplatinic acid (or hydrates thereof, e.g., H₂PtCl₆.6H₂O), potassium platinum(II) chloride (K₂PtCl₄), platinum(II) acetate, platinum(II) acetylacetonate, platinum(IV) acetate, nickel(II) acetylacetonate, nickel(II) nitrate, nickel(II) chloride, cobalt(II) acetylacetonate, iron(II) acetylacetonate, hydrates thereof, and combinations thereof. Examples of the Group 8-11 metal source 221 can also include Au, Ag, and Pd having the same or similar ligands, and combinations thereof.

Conditions 222 effective to form the Group 8-11 metal complex 211 (e.g., the Group 8-11 metal amine) of the third precursor can include similar conditions for forming the Group 10-11 metal complex 205 described above with respect to conditions 204. For example, the Group 8-11 metal source 221 and the nitrogen-containing compound 223 can be mixed, stirred, and/or agitated at a temperature greater than about 40° C., such as greater than about 60° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 290° C. to about 230° C., such as from about 200° C. to about 220° C. In some aspects, the reaction temperature to form the Group 8-11 metal complex 211 can be from about 150° C. to about 250° C. or from about 180° C. to about 240° C. Higher or lower temperatures can be used when appropriate. The reaction time to form the Group 8-11 metal complex 211 can be about 1 min or more or about 24 h or less, such as from about 5 min to about 6 h, such as from about 10 min to about 5.5 h, such as from about 15 min to about 5 h, such as from about 30 min to about 4 h, such as from about 45 min to about 3 h, such as from about 1 h to about 2 h. The reaction time to form the Group 8-11 metal complex 211 can be more or less depending on, e.g., the level of conversion desired. Any reasonable operating pressure can be used during formation of the Group 8-11 metal complex 211. Conditions 222 effective to the Group 8-11 metal complex 211 can optionally include utilizing a non-reactive gas, e.g., N₂ and/or Ar). For example, a mixture of the Group 8-11 metal source 221 and the nitrogen-containing compound 223 can be placed under these or other non-reactive gases to, e.g., degas various components or otherwise remove oxygen from the reaction mixture.

The second conditions in operation 320 can include introduction conditions 212 and reaction conditions 214 of FIG. 2A. The introduction conditions 212 refer to the conditions at which the third precursor comprising the Group 8-11 metal complex 211 is introduced to the mixture 209 comprising the Group 10-11 metal complex 205, the phosphorous-containing compound 207, and optional solvent by, e.g., injection, addition, or otherwise combining the third precursor with the mixture 209. The reaction conditions 214 refer to the conditions at which the third precursor comprising the Group 8-11 metal complex 211 and one or more components of the mixture 209 are reacted. The introductions conditions 212 and reaction conditions 214 can be the same or different.

The introduction conditions 212 include an introduction temperature. The introduction temperature, or injection temperature, of operation 320 can be about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the introduction temperature or injection temperature of operation 320 can be from about 80° C. to about 320° C., such as from about 80° C. to about 150° C. or from about 180° C. to about 320° C., such as from about 200° C. to about 300° C. Higher or lower introduction/injection temperatures can be used when appropriate.

The resultant mixture containing the Group 10-11 metal complex 205, the phosphorous-containing compound 207, the Group 8-11 metal complex 211, and the optional solvent, can be stirred, mixed or otherwise agitated at the introduction temperature for a time period of about 1 min or more or about 24 h or less, such as from about 1 min to about 12 h, such as from about 5 min to about 6 h, such as from about 10 min to about 3 h, such as from about 15 min to about 1 h. The introduction conditions 212 of operation 320 can optionally include introducing N₂, Ar, and/or other non-reactive gases prior to, during, and/or after, introducing the third precursor comprising the Group 8-11 metal complex 211 to the mixture 209.

After introduction of the Group 8-11 metal complex 211 to the mixture 209, one or more components of the resultant mixture react, under reaction conditions 214, to form the first bimetallic structure 213. Here, the reaction conditions 214 of operation 320 can include heating the mixture containing the Group 10-11 metal complex 205, the phosphorous-containing compound 207, the Group 8-11 metal complex 211, and the optional solvent, at a reaction temperature of about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. In some aspects, the reaction temperature of reaction conditions 214 can be from about 80° C. to about 320° C., such as from about 80° C. to about 150° C. or from about 180° C. to about 320° C., such as from about 200° C. to about 300° C. Higher or lower temperatures can be used when appropriate. The reaction conditions 214 of operation 320 can include a time of about 1 min or more or about 24 or less, such as from about 1 min to about 12 h, such as from about 5 min to about 3 h, such as from about 10 min to about 1 h. Higher or lower temperatures and/or more or less periods of time can be used when appropriate. Stirring, mixing, and/or agitation can be performed to, e.g., ensure homogeneity. The reaction conditions 214 of operation 320 can include introducing N₂, Ar, and/or other non-reactive gases before, during, and/or after reaction of the one or more components.

In some examples, the reaction conditions 214 include an operating temperature that is higher than, less than, or equal to the operating temperature of the introduction conditions 212.

After a suitable time, the reaction product mixture comprising the first bimetallic structure 213 formed during operation 320 can be subjected to filtration, separation, cleaning, quenching, washing, purification, and/or other suitable processes to remove undesired components and isolate the first bimetallic structure 213 from the other components of the reaction product mixture. For example, the reaction product mixture comprising the first bimetallic structure 213 can be centrifuged to separate the first bimetallic structure 213 (which may be in the form of particles) from the reaction product mixture. Additionally, or alternatively, the first bimetallic structure 213 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the first bimetallic structure 213 from other components in the reaction product mixture. As an example, a solvent or mixture of solvents can be added to the first bimetallic structure 213 and the resultant mixture centrifuged. The supernatant can be discarded and the remaining pellet can be dispersed in a suitable solvent or mixture of solvents. The resultant pellet and solvent(s) can then be centrifuged to obtain the first bimetallic structure 213.

As a non-limiting example of operation 320, an alkylphosphine with or without a nitrogen-containing compound, such as OLA, can be degassed using a non-reactive gas while agitating. The alkylphosphine with or without a nitrogen-containing compound can be heated to a temperature of about 275° C. to about 350° C. A copper amine is then added to the alkylphosphine and agitated. The resultant mixture (e.g., mixture 209) containing the copper amine and the alkylphosphine is then set to introduction conditions 212 such as an introduction temperature from about 100° C. to about 140° C., stirred for a suitable period of time, under suitable pressures, with or without the presence of a non-reactive gas. The third precursor comprising a Group 8-11 metal amine, with or without a nitrogen-containing compound, is then added to the mixture at this introduction temperature and stirred under the introduction conditions 212 for a suitable period of time, under suitable pressures, with or without the presence of a non-reactive gas. At a selected time point, the mixture of the Group 8-11 metal amine, alkylphosphine, and copper amine are placed under the reaction conditions 214. The reactions conditions 214 can be the same or different conditions as the introduction conditions 212. In this example, the reaction conditions 214 include heating the mixture of the Group 8-11 metal amine, alkylphosphine, copper amine, and optional nitrogen-containing compound(s) (as solvent(s)), at a temperature from about 225° C. to about 275° C. for a suitable period of time, under suitable pressures, and with or without the presence of a non-reactive gas, to form the first bimetallic structure 213. The first bimetallic structure 213 can then be subjected to filtration, separation, cleaning, quenching, washing, purification, and/or other suitable processes to remove undesired components and/or isolate the first bimetallic structure 213 from the other components of the reaction mixture.

Process 300 further includes converting, under third conditions, the first bimetallic structure 213 to a second bimetallic structure 218 at operation 330. The second bimetallic structure 218 can be a nanoframe. The second bimetallic structure 218 can be at least partially hollow, substantially hollow, or hollow. Chemical and physical properties of the second bimetallic structure 218 are also described above. In FIG. 2A, the third conditions are designated by numeral 216.

Conditions 216 effective to form the second bimetallic structure can include etching with an etching agent. Etching can include subjecting the first bimetallic structure 213 to an etching treatment sufficient to form a second bimetallic structure 218 having, e.g., faces (or sides) that are at least partially disordered, defective. The nanostructures can be characterized by HRTEM. For example, a first bimetallic structure 213 can have a regular rhombic dodecahedral morphology while the second bimetallic structure 218 has an irregular rhombic dodecahedral morphology. Additionally, or alternatively, the second bimetallic structure is in the form of a nanoframe.

The etching process of operation 330 can be performed by immersing, soaking, or otherwise subjecting the first bimetallic structure 213 to an etching agent. In some aspects, the etching agent includes an acid, a Group 8-11 metal complex, or a combination thereof.

When the etching agent includes an acid, the acid can be acetic acid, phosphoric acid, carbonic acid, propionic acid, sulfuric acid (H₂SO₄), nitric acid (HNO₃), hydrochloric acid (HCl), or combinations thereof. The etching agent may be provided as a solution, for example, an aqueous solution. In some aspects, the concentration of acid in the etching agent is from about 0.01 M to about 10 M, such as from about 0.1 M to about 2 M, such as from about 0.5 M to about 1.5 M, such as from about 1 M to about 1.25 M. In some examples, a molar ratio of first bimetallic structure 213 to acid is from about 1:500 to about 1:1, such as from about 1:200 to about 1:1, such as from about 1:50 to about 1:1, such as from about 1:20 to about 1:1 based on the starting material molar ratio used for the reaction. In some aspects, the molar ratio of first bimetallic structure 213 to acid is from about 1:10 to about 1:1, such as from about 1:5 to about 1:1, such as from about 1:2 to about 1:1 based on the starting material molar ratio used for the reaction.

When the etching agent includes a Group 8-11 metal complex 225, the Group 8-11 metal complex 225 can be the same, or similar to, the Group 8-11 metal complex 211 described above, such as a metal amine. In some aspects, the metal of the Group 8-11 metal complex 225 utilized for operation 330 has a higher oxidation potential of one or more metals of the first bimetallic structure. For example, when the first bimetallic structure includes Cu and/or Ni, the metal of the Group 8-11 metal complex 225 can be Pd, Pt, Ag, or Au. The Group 8-11 metal complex 225 can be in the form of a solution and/or suspension. In some examples, a molar ratio of first bimetallic structure 213 to Group 8-11 metal complex 225 is from about 1:100 to about 1:1, such as from about 1:50 to about 1:1, such as from about 1:20 to about 1:1, such as from about 1:10 to about 1:1 based on the starting material molar ratio used for the reaction. In some aspects, the molar ratio of first bimetallic structure 213 to Group 8-11 metal complex 225 is from about 1:8 to about 1:1, such as from about 1:5 to about 1:1, such as from about 1:2 to about 1:1 based on the starting material molar ratio used for the reaction.

When desired, a suitable solvent such as hydrocarbon solvents (e.g., octadecene) and/or ether solvents (e.g., phenyl ether) can be utilized.

When desired, a stabilizer such as polyvinylpyrrolidone (PVP), polyethylene glycol (PEG), polyacrylic acid (PAA), polyamines, or combinations thereof can be used during operation 330. The polyvinylpyrrolidone utilized can have a molecular weight from about 20,000 g/mol to about 60,000 g/mol) based on the starting material molar ratio used for the reaction. Suitable surfactants (e.g., cetyltrimethylammonium bromide, ascorbic acid, cetyltrimethylammonium chloride, citric acid, or combinations thereof), growth modifiers, nanoparticle dispersants, and/or reducing agents can optionally be utilized for operation 330.

In some examples, a molar ratio of first bimetallic structure 213 to stabilizer is from about 1:200 to about 1:1, such as from about 1:100 to about 1:1, such as from about 1:50 to about 1:1, such as from about 1:10 to about 1:1 based on the starting material molar ratio used for the reaction. In some aspects, the molar ratio of first bimetallic structure 213 to stabilizer is from about 1:8 to about 1:1, such as from about 1:5 to about 1:1, such as from about 1:2 to about 1:1 based on the starting material molar ratio used for the reaction.

Conditions 216 effective to form the second bimetallic structure 218 (e.g., the nanoframe) can include a reaction temperature and a reaction time. The reaction temperature to form the second bimetallic structure 218 can be greater than about −10° C., such as greater than about 0° C., such as greater than about 15° C., such as from about 20° C. to about 120° C., such as from about 30° C. to about 110° C., such as from about 40° C. to about 100° C., such as from about 50° C. to about 90° C., such as from about 60° C. to about 80° C. Higher or lower temperatures can be used when appropriate. The reaction time to form the second bimetallic structure 218 can be about 30 seconds or more and/or about 24 h or less, such as from about 1 min to about 16 h, such as from about 5 min to about 10 h, such as from about 15 min to about 5 h, such as from about 30 min to about 3 hours, such as from about 45 min to about 5 h. In some aspects, the reaction time to form the second bimetallic structure is about 1 h or less, such as about 30 minutes or less, such as about 5 minutes or less, such as about 1 min or less, such as from about one second to about one minute, such as from about 1 second to about 30 seconds. The reaction time to form the second bimetallic structure 218 can be more or less depending on, e.g., the level of conversion desired. Any reasonable pressure can be used during formation of the second bimetallic structure 218.

Conditions 216 effective to form the second bimetallic structure 218 (e.g., the nanoframe) can include stirring, mixing, and/or agitation via, e.g., sonication. Conditions 216 effective to form the second bimetallic structure 218 can optionally include utilizing a non-reactive gas, such as N₂ and/or Ar. For example, a first bimetallic structure 213 and etching agent, with or without stabilizer, surfactant dispersant, and/or growth modifier, can be placed under these or other non-reactive gases to, e.g., degas various components or otherwise remove oxygen from the reaction mixture.

In some aspects, the reaction product comprising the second bimetallic structure 218 can be subjected to filtration, separation, cleaning, quenching, washing, purification, and/or other suitable processes to remove undesired components and isolate the second bimetallic structure 218 from the other components of the reaction mixture. For example, the reaction product comprising the second bimetallic structure 218 (which may be in the form of particles) can be centrifuged to separate the second bimetallic structure 218 from the mixture. Additionally, or alternatively, the second bimetallic structure 218 can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the second bimetallic structure 218 from other components in the reaction mixture. As an example, a solvent or a mixture of solvents can be added to the second bimetallic structure 218 and the resultant mixture centrifuged. The supernatant can be discarded and the remaining pellet can be dispersed in a suitable solvent or mixture of solvents. The resultant pellet and solvent(s) can then be centrifuged to obtain the second bimetallic structure 218. In these and other aspects, the pellet comprising the second bimetallic structure 218 can be re-solubilized or re-suspended in a suitable solvent such as water or those described above.

FIG. 3B is a flowchart showing selected operations of an example process 350 for producing a bimetallic nanoframe according to at least one aspect of the present disclosure. The process 350 includes forming a mixture 209, under first conditions, comprising a Group 10-11 metal complex 205 and a phosphorous-containing compound 207 at operation 360. The Group 10-11 metal complex 205, phosphorous-containing compound 207, the mixture 209, and the first conditions of operation 360 are described above in relation to process 300 of FIG. 3A. The process 350 further includes introducing a Group 8-11 metal complex 211 with the mixture 209 to form a bimetallic structure (e.g., the first bimetallic structure 213) at operation 370. The bimetallic structure formed can have the formula (M¹)ₐ(M²)_{b}(P)_{c}(N)_{d} as described above. The Group 8-11 metal complex 211, the mixture 109, the first bimetallic structure 213 formed, and the second conditions of operation 370 are described above in relation to process 300 of FIG. 3A.

The process further includes etching the bimetallic structure to form a bimetallic nanoframe (e.g., second bimetallic structure 218) at operation 380. Etching agents for operation 380 include acid, the Group 8-11 metal complex 225, or a combination thereof. Optional stabilizers, surfactants, growth modifiers, nanoparticle dispersants, and/or reducing agents, can be used. The bimetallic nanoframe can have the formula (M¹)ₐ(M²)_{b}(P)_{c}(N)_{d} as described above. Chemical and physical properties of the bimetallic nanoframe are also described above. Conditions for operation 380 are described above in relation to process 300 of FIG. 3A.

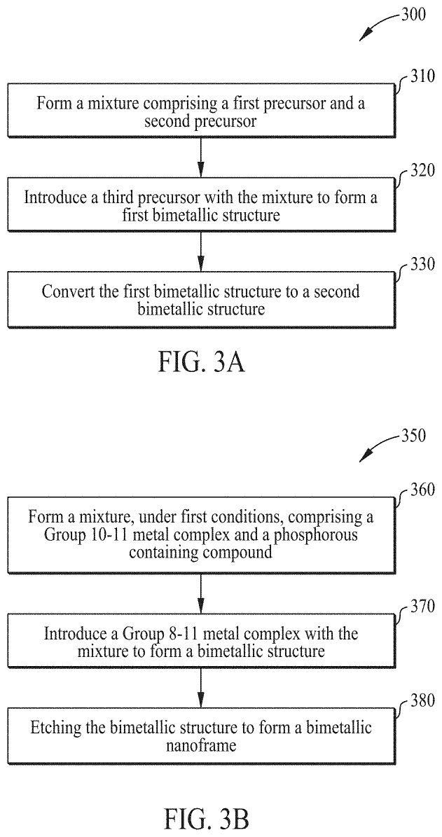

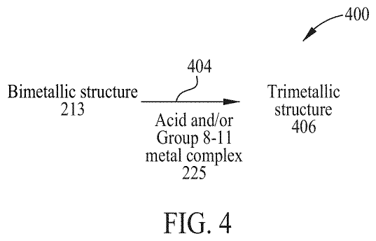

FIG. 4A shows an example reaction diagram 400 for forming a trimetallic structure 406 according to at least one aspect of the present disclosure. In some aspects, the trimetallic structure 406 can be at least partially hollow and/or characterized as a nanoframe. FIG. 5A is a flowchart showing selected operations of an example process 500 for producing the trimetallic structure 406 according to at least one aspect of the present disclosure.

The process 500 includes forming a mixture comprising a first precursor and a second precursor at operation 510 and introducing a third precursor with the mixture to form a bimetallic structure at operation 520. Operations 510 and 520 can be performed in the same or similar manner as operations 310 and 320 of process 300.

The process 500 further includes converting, under conversion conditions 404, the bimetallic structure 213 to the trimetallic structure 406 at operation 530. Operation 530 can be performed using the same or similar etching agents (e.g., acid and/or Group 8-11 metal complex 225) on the bimetallic structure 213 described above with respect to operation 330 of process 300. The conversion conditions 404 for converting the can be similar to those conditions 216 described above with respect to operation 330 of process 300. However, the formation of the trimetallic structure can be controlled by changing the molar ratio of the etching agent to the bimetallic structure, the temperature of the etch operation, the etching reaction rate, and/or the amount of surfactant utilized.

When the etching agent includes an acid, at least a portion of the bimetallic structure 213 can be converted to the trimetallic structure 406 using a molar ratio of the bimetallic structure 213 to acid from about 1:200 to about 1:1, such as from about 1:100 to about 1:1, such as from about 1:50 to about 1:1, such as from about 1:10 to about 1:1 based on the starting material molar ratio used for the reaction. In some aspects, the molar ratio of first bimetallic structure 213 to acid to form the trimetallic structure 406 is from about 1:200 to about 1:1, such as from about 1:100 to about 1:50, such as from about 1:10 to about 1:1 based on the starting material molar ratio used for the reaction.

When the etching agent includes a Group 8-11 metal complex 225, at least a portion of the bimetallic structure 213 can be converted to the trimetallic structure 406 using a molar ratio of first bimetallic structure 213 to Group 8-11 metal complex 225 from about 1:100 to about 1:1, such as from about 1:50 to about 1:1, such as from about 1:20 to about 1:1, such as from about 1:5 to about 1:1 based on the starting material molar ratio used for the reaction. In some aspects, the molar ratio of first bimetallic structure 213 to acid to form the trimetallic structure 406 is from about 1:100 to about 1:1, such as from about 1:50 to about 1:1, such as from about 1:5 to about 1:1 based on the starting material molar ratio used for the reaction.

FIG. 5B is a flowchart showing selected operations of an example process 550 for producing a trimetallic nanoframe according to at least one aspect of the present disclosure. The process 550 includes forming a mixture 209, under first conditions, comprising a Group 10-11 metal complex 205 and a phosphorous-containing compound 207 at operation 560. The Group 10-11 metal complex 205, phosphorous-containing compound 207, the mixture 209, and the first conditions of operation 560 are described above in relation to processes 300 and 350. The process 550 further includes introducing a Group 8-11 metal complex 211 with the mixture 209 to form a bimetallic structure (e.g., the first bimetallic structure 213) at operation 570. The bimetallic structure formed can have the formula (M¹)ₐ(M²)_{b}(P)_{c}(N)_{d} as described above. The Group 8-11 metal complex 211, the first bimetallic structure 213 formed, and the second conditions of operation 570 are described above in relation to processes 300 and 350.

The process further includes etching the bimetallic structure to form a trimetallic nanoframe (e.g., second bimetallic structure 218) at operation 580. Etching agents for operation 580 include acid, the Group 8-11 metal complex 225, or a combination thereof. Optional stabilizers, surfactants, growth modifiers, nanoparticle dispersants, and/or reducing agents, can be used. The trimetallic nanoframe can have the formula (M¹)ₐ(M²)_{b}(P)_{c}(N)_{d} as described above. Chemical and physical properties of the trimetallic nanoframe are also described above. Conditions for operation 580 are described above in relation to process 500 of FIG. 5A.

The processes for forming the bimetallic and trimetallic structures useful for catalyst compositions described herein are efficient and utilize low-cost materials.

### Processes for Forming Catalyst Compositions

Aspects of the present disclosure also generally relate to processes for forming catalyst compositions that are useful for various reactions. The processes enable, e.g., controlling and/or tuning the catalytic activity and/or optical and electrical properties of the metallic structures (e.g., the bimetallic nanoframes and/or trimetallic nanoframes) in the catalyst compositions. Relative to metallic crystals, metallic nanoframes have a higher concentration of defect sites as well as a higher surface area. By absorbing hydrogen atoms onto the defect sites, the activity of the metallic structures can be controlled and improved. By absorbing hydrogen atoms onto the

In some aspects, a process for forming a catalyst composition includes introducing an electrolyte material and an amphiphile material to a metallic structure. As described above, the metallic structure can be at least partially hollow and/or be characterized as a nanoframe,

The metallic structure can be in the form of a monolayer film or a film including multiple layers, e.g., such as about 10 or fewer layers, such as about 5 or fewer layers. Additionally, or alternatively, the metallic structure can be in the form of particles. The metallic structure can be disposed on a substrate, electrode, or both. The metallic structure can be formed by a variety of methods, as described above.

Typically, the electrolyte material is an aqueous solution comprising one or more electrolytes and the amphiphile material is an aqueous solution comprising one or more amphiphiles (or amphiphile compounds). Here, one or more of the electrolyte materials and one or more of the amphiphile materials contact the metallic structure under conditions effective to adsorb hydrogen atoms to the metallic structure and/or conditions effective to dispose hydrogen atoms on one or more surfaces of the metallic structure. Amounts of materials, ratios of materials, etc. that are used to form the catalyst compositions provided herein are described above.

In at least one aspect, effective conditions to form the catalyst composition include a temperature from about 15° C. to about 60° C., such as from about 20° C. to about 40° C., such as from about 25° C. to about 30° C., from about 30° C. to about 35° C., or from about 35° C. to about 40° C.; and/or a time of at least about 1 minute (min), such as from about 5 min to about 6 hours (h), such as from about 10 min to about 5.5 h, such as from about 15 min to about 5 h, such as from about 30 min to about 4 h, such as from about 45 min to about 3 h, such as from about 1 h to about 2 h. In some aspects, the conditions can include stirring, mixing, and/or agitation to ensure homogeneity of the electrolyte material(s) and amphiphile material(s). In at least one aspect, the metallic structure is immersed, or at least partially immersed, in the electrolyte material and the amphiphile material. The conditions can also include utilizing a non-reactive gas, such as N₂ and/or Ar. Any suitable pressure can be used.

In some aspects, processes for forming a catalyst composition includes electrochemically polarizing the metallic structure (which may be in the form of a film and/or particles) at negative potentials, by, e.g., performing cyclic voltammetry (CV) before, during, and/or after introducing one or more electrolyte materials and/or before, during, and/or after introducing one or more amphiphilic materials to the metallic structure. CV cycling can be performed at an applied voltage from about ˜1 V versus RHE to about 0 V versus RHE, such as from about ˜0.8 V versus RHE to about ˜0.2 V versus RHE, such as from about ˜0.6 V versus RHE to about ˜0.4 V versus RHE. In some aspects, chronoamperometry can be performed before, during, and/or after introducing one or more electrolyte materials and/or one or more amphiphilic materials to the metallic structure. Chronoamperometry can be performed at an applied voltage from about ˜0.8 V versus RHE to about ˜0.4 V versus RHE, such as from about ˜0.7 V versus RHE to about ˜0.5 V versus RHE. Such operations can aid in the adsorption of hydrogen atoms to the metallic structure.

In some aspects, processes for forming a catalyst composition can include providing a metallic structure (which can be in the form of a film and/or particles) and/or disposing/adsorbing hydrogen atoms on one or more surfaces of the metallic structure. The metallic structure can be disposed on a substrate (such as a Si-containing substrate), one or more electrodes, or both. The electrode can be made of, or include, any suitable material such as graphene, glassy carbon, copper, nickel, silver, and titanium.

Processes for changing one or more properties of a metallic structure are also described. Such properties include catalytic activity, hydrogen atom adsorption, photoluminescence, and electrical properties. The processes for changing one or more properties of a metallic structure can include introducing/adding hydrogen atoms to a metallic structure (which can be in the form of a particle), or to a surface thereof. In some aspects, adding introducing/adding hydrogen atoms includes electrochemically polarizing the metallic structure at positive potentials, by, e.g., performing cyclic voltammetry (CV) before, during, and/or after introducing one or more electrolyte materials and/or before, during, and/or after introducing one or more amphiphilic materials to the metallic structure. CV cycling can be performed at an applied voltage from about 0 V versus RHE to about 1.3 V versus RHE, such as from about 0 V versus RHE to about 1.2 V versus RHE, such as from about 0 V versus RHE to about 1.1 V versus RHE. In some aspects, chronoamperometry can be performed before, during, and/or after introducing one or more electrolyte materials and/or one or more amphiphilic materials to the metallic structure. Chronoamperometry can be performed at an applied voltage from about ˜0.04 V versus RHE to about ˜0.01 V versus RHE, such as from about ˜0.03 V versus RHE to about ˜0.02 V versus RHE.

### Devices Incorporating the Catalyst Compositions

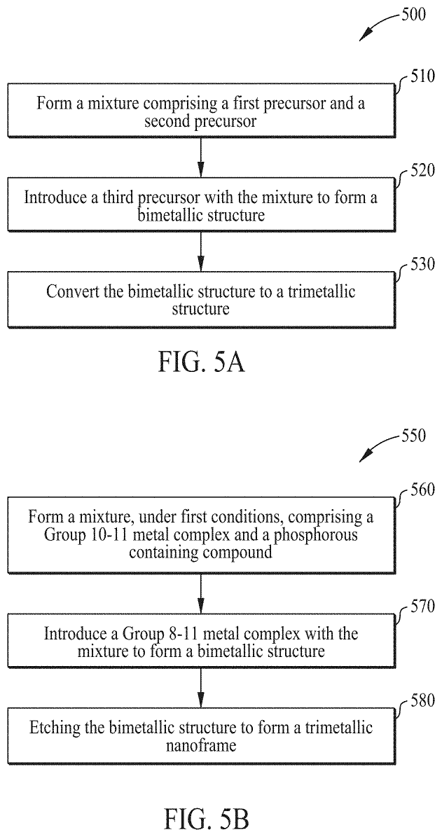

FIG. 6 is an illustration of an example device 600 for performing a catalytic reaction, e.g., a hydrogen evolution reaction, according to at least one aspect of the present disclosure. The materials utilized for the device set-up are non-limiting. The device includes a reactor 602 which can be a standard three-electrode electrolysis cell. A working electrode 603, reference electrode 604, and a counter electrode 605 are placed in a solution 606. The materials used for the working electrode 603, reference electrode 604, and the counter electrode 605 can be any suitable material used for such electrodes. The solution 606 can be an aqueous solution of an electrolyte and a molecular mediator material 608, such as an aqueous solution of about 0.05 M to about 0.5 M H₂SO₄ and about 0.1 mM to about 50 mM SDS, though higher or lower concentrations, as well as additional or alternative electrolytes/molecular mediators are contemplated. The solution 606 can be saturated with a non-reactive gas such as N₂ or other suitable gas.

A reaction portion 609 of the working electrode 603 includes a metallic structure 601 (e.g., a bimetallic nanoframe and/or a trimetallic nanoframe) disposed thereon. The reaction portion 609 of the working electrode is immersed in the solution 606. The metallic structure 601, which acts as a catalyst in the reaction, can be placed on the reaction portion 609 of the working electrode 603 by, e.g., micropipette. Here, and in some examples, the metallic structure 601 can be dissolved or suspended in a suitable liquid or suspension to form an ink or a gel. The ink or gel can be spread onto the reaction portion 609 of the working electrode 603 via micropipette. The ink or gel can be dried on the reaction portion 609 of the working electrode 603 at a suitable temperature, e.g., about room temperature, prior to immersion in the solution 606.

During operation, a portion of the molecular mediator material 608 can anchor onto a surface of the metallic structure 601 as shown in FIG. 6 to promote, e.g., proton transfer. In addition, the solution 606 includes free molecular mediator material 608 that is not anchored to the surface of the metallic structure 601.

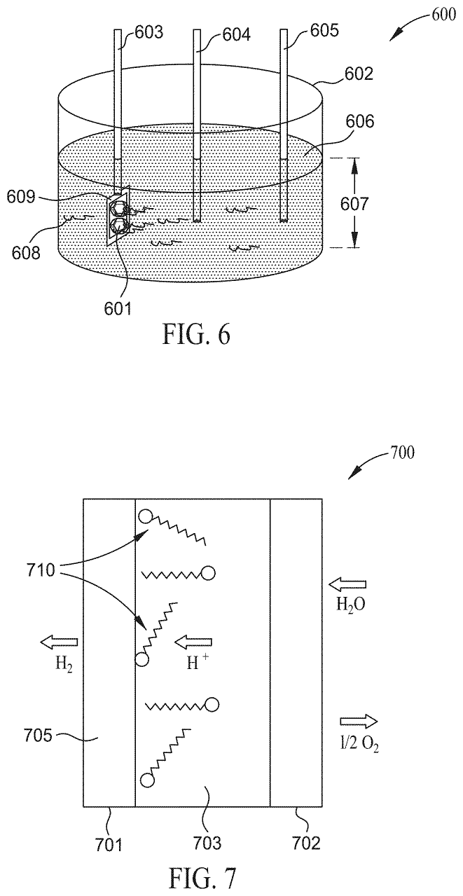

FIG. 7 is an illustration of an example device 700 for performing HER. The device includes a cathode 701, an anode 702, and an electrolyte 703 positioned between the cathode 701 and the anode 702. The cathode includes metallic nanoframes 705. The electrolyte 703 includes the molecular mediator material 710 (e.g., amphiphile and/or amphiphile compound). The molecular mediator material (e.g., amphiphile and/or amphiphile compound) can increase the H⁺ coverage on the metallic nanoframes available to catalyze the HER:

2H⁺2e⁻→H₂

The cathode 701 can further include a composite material that includes cathode active material particles in a three-dimensional cross-linked network of carbon nanotubes.

### Methods of Using Catalyst Compositions

The present disclosure also relates to methods of using the catalyst compositions described herein. For example, the catalyst compositions can be used for various conversion reactions such as hydrogen evolution reactions, e.g., hydrogen evolution from water, carbon dioxide (CO₂) conversion into fuels and chemicals, reduction reactions, oxygen reduction reactions, and complicated organic reactions, such as annulation chemistry and aerobic dehydrogenation reactions. As described above, the properties of the catalyst compositions made by processes described herein are improved over those compositions made by conventional methods. For example, the catalyst compositions described herein exhibit improved catalytic activity due to, e.g., increased amounts of H-atoms adsorbed on the metallic structure.

In some examples, a method of using the catalyst composition can include introducing the catalyst compositions to a reactant to form a product. For example, a process for converting water to conversion product(s) can include introducing an aqueous electrolyte material and an aqueous amphiphile material with a metallic structure, and obtaining conversion products, e.g., hydrogen. The process can further include introducing a voltage before, during, and/or after introducing one or more electrolyte materials to the metallic structure and/or before, during, and/or after introducing one or more amphiphilic materials to the metallic structure. Applied voltages can be from about −0.6 V versus RHE to about 0.3 V versus RHE, such as from about −0.5 V versus RHE to about 0.3 V versus RHE, such as from about −0.4 V versus RHE to about 0.3 V versus RHE, though higher or lower applied voltages are contemplated. In some aspects, chronoamperometry can be performed before, during, and/or after introducing one or more electrolyte materials and/or one or more amphiphilic materials to the metallic structure. Chronoamperometry can be performed at an applied voltage from about −0.04V versus RHE to about −0.01 V versus RHE, such as from about −0.03 V versus RHE to about −0.02 V versus RHE, though higher or lower applied voltages are contemplated.

As another example, a process for reducing CO₂ to conversion product(s) can include introducing CO₂ with a catalyst composition to obtain conversion products, e.g., carbon monoxide, methane, ethane, propanol, formic acid, ethanol, allyl alcohol, ethylene, or combinations thereof.

The catalyst composition includes an aqueous electrolyte material, an aqueous amphiphile material, and a metallic structure. The process can further include introducing a voltage before, during, and/or after introducing the CO₂ with the catalyst composition. Applied voltages can be from about −0.6 V versus RHE to about 0.3 V versus RHE, such as from about −0.5 V versus RHE to about 0.3 V versus RHE, such as from about −0.4V versus RHE to about −0.3 V versus RHE, though higher or lower applied voltages are contemplated. In some aspects, chronoamperometry can be performed before, during, and/or after introducing one or more electrolyte materials and/or one or more amphiphilic materials to the metallic structure. Chronoamperometry can be performed at an applied voltage from about −0.04 V versus RHE to about −0.01 V versus RHE, such as from about −0.03 V versus RHE to about −0.02 V versus RHE, though higher or lower applied voltages are contemplated.

Accordingly, and in some aspects, the catalyst compositions can be used in such applications and/or can be incorporated into desired devices (e.g., reactors) useful for such applications.

In some aspects, the hydrogen evolution reaction can be performed in a device. For example, the device can be a multilayer structure contacting an electrolyte material and an amphiphile material. Here, the multilayer structure can be, e.g., immersed in the electrolyte material and/or amphiphile material. The multilayer structure can include a substrate (such as a Si-containing substrate, such as SiO₂). A source electrode and a drain electrode can be disposed over at least a portion of the substrate, and a metallic structure as described herein can be disposed on at least a portion of the source electrode and at least a portion of the drain electrode.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (e.g. amounts, dimensions, etc.) but some experimental errors and deviations should be accounted for.

### EXAMPLES

Copper chloride (CuCl, 99.0%), tributylphosphine (TBP, 99%), trioctylphosphine (TOP, 97%), oleylamine (OLA, 70%), nickel acetylacetonate (Ni(acac)₂), nickel nitrate (Ni(NO₃)₂), nickel chloride (NiCl₂), cobalt acetylacetonate (Co(acac)₂), iron (II) acetylacetonate (Fe(acac)₂), polyvinylpirrolidone (PVP, m.w.=55,000), toluene (99.9%), acetone (99%), chloroform (99.9%), and 1-octadecene (ODE, 98%) were purchased from Sigma-Aldrich. Hexadecylamine (HDA) and Tetradecylamine (TDA, >96%) was purchased from TCI America. Dihydrogen hexachloroplatinate hexahydrate (H2PtCl6.6H2O, 99.9%) and acetic acid (CH₃COOH) were purchased from Alfa Aesar. Hexane (99%), methanol (99%), and ethanol (200 proof) were purchase from Fisher Chemicals. All chemicals were used as received.

The surface morphologies were investigated by a scanning electron microscope (SEM, QUANTA FEG 650) from FEI with a field emitter as electron source. A Bruker D8 Advance X-ray diffractometer with Cu Kα radiation operated at a tube voltage of 40 kV and a current of 40 mA was used to obtain X-ray diffraction (XRD) patterns. Transmission electron microscopy (TEM) images were captured using an FEI Tecnai 20 microscope with an accelerating voltage of 200 kV. Energy Dispersive X-Ray spectrometer (EDS) mapping image and the high-angle annular dark-field (HAADF) image were collected by employing the probe-corrected Titan³™ 80-300 S/TEM with an accelerating voltage of 300 kV. XPS data were collected on an XPS spectrometer from PHI 500 Versa Probe (ULVAC-PHI, Kanagawa, Japan) with Al Kα radiation (1486.6 eV).

### Example 1: Synthesis of Example Metal Amines

Ex. 1A. Synthesis of Copper-TDA (Cu-TDA): Copper (I) chloride (˜100 mg, ˜1 mmol), TDA (˜240 mg), and ODE (˜2 mL) were mixed in a flask under an Ar or N₂ environment to form a solution/suspension. After degassing for about 20 minutes, the solution/suspension was heated to about 200° C. under Ar and/or N₂. After keeping the solution/suspension at this temperature for about 10 minutes, the solution/suspension was cooled to room temperature. This Cu-TDA solution/suspension was utilized as a Cu-TDA stock solution.

Ex. 1B. Synthesis of Nickel-OLA (Ni-OLA): Ni(acac)₂ (˜128 mg, ˜0.5 mmol) and OLA (˜4 mL) were mixed in a flask under an Ar or N₂ environment to form a solution/suspension. The solution/suspension was then heated at about 50-150° C. and shaken for about 5 minutes. The solution/suspension was then cooled to about room temperature. This Ni-OLA solution/suspension was utilized as a Ni-OLA stock solution.

### Example 2: Synthesis of Example Polyhedral Nanoparticles

Ex. 2A. Synthesis of Cu—Ni polyhedral nanoparticles: The PtNi polyhedral nanoparticles capped with HDA were synthesized through the following procedure. HDA (˜40 mmol, 10.0 g) and H₂PtCl₆.6H₂O (˜0.1 mmol, 51.7 mg) were added into a 50 mL three-neck flask equipped with a magnetic stir bar. The reaction system was degassed with nitrogen gas throughout the whole experiment to remove O₂. The temperature was increased to about 200° C., and the reaction mixture quickly turned gray under stirring. As soon as the reaction mixture changed color, Ni(acac)₂ (˜0.2 mmol, 51.2 mg) in ˜2 mL of OLA was injected into the reaction mixture. The reaction temperature was kept at about 200° C. for about 25 min. After this, ethanol was added and the mixture was centrifuged at 5000 rpm for 5 min to remove excess reactants and surfactants. The synthesis produced PtNi rhombic dodecahedrons.

Ex. 2B. Synthesis of Cu—Ni polyhedral nanoparticles: OLA (70%, ˜6 mL) was added to a 50 mL three-neck flask where oxygen was removed by Ar or N₂ blowing for ˜20 min. After degassing, TOP (˜1 mL) was injected into the three-neck flask under an Ar or N₂ environment. After degassing for about 20 minutes, the mixture was rapidly heated to about 300° C. under Ar and/or N₂. Next, ˜2 mL of the Cu-TDA stock solution (Ex. 1A) was quickly injected into the three-neck flask, and the reaction solution turned to a red color. The reaction solution was then cooled to a temperature of about 120° C. and then ˜4 mL of the Ni-OLA stock solution (Ex. 1B) was injected, and the reaction solution was maintained at about 120° C. After about 1 hour at about 120° C., the reaction solution was heated to about 250° C. After about 5 minutes at about 250° C., the reaction solution was cooled to about room temperature and about 5 mL of hexane (or other hydrophobic solvent such as toluene and chloroform) and about 5 mL of ethanol were added into the three-neck flask. The resulting Cu—Ni polyhedral nanoparticles were isolated by centrifuging at about 4000 rpm for about 5 minutes, and the supernatant was discarded. Hexane (about 10 mL) was then added to the pellet and the mixture was centrifuged at about 4000 rpm for ˜5 minutes. Another amount of hexane (about 10 mL) was added to the pellet and the mixture was centrifuged at about 4000 rpm for about 5 minutes. The two washings aid removal of unreacted precursor and other materials. The Cu—Ni polyhedral nanoparticles can be stored in a hydrophobic solvent (e.g., hexane, toluene, and/or chloroform).

Ex. 2C. Syntheses of Cu—Ni Polyhedral Nanoparticles: For Ex. 2B, a similar procedure to Ex. 2A was followed. However, a different Ni stock solution was used to form the nanoparticles. Here, the Ni stock solution was can be made from nickel nitrate (Ex. 2F) or nickel chloride (Ex. 2G) instead of nickel acetylacetonate of Ex. 1B. The nickel nitrate and nickel chloride were then made into Ni-OLA stock solutions in a similar procedure as described for Ex. 1B.

Cu—Ni polyhedral nanoparticles can also be formed using tributylphosphine (TBP) instead of TOP in the procedure of 2A. Cu—Co polyhedral nanoparticles can be synthesized using a similar procedure as that described in Ex. 2A, except that a Co-OLA precursor was used instead of the Ni-OLA precursor. The Co-OLA precursor was formed using a similar procedure as that described in Ex. 1B, except that Co(acac)₂ was used as the metal source instead of Ni(acac)₂. Cu—Fe polyhedral nanoparticles can be synthesized using a similar procedure as that described in Ex. 2A, except that a Fe-OLA precursor was used instead of the Ni-OLA precursor. The Fe-OLA precursor was formed using a similar procedure as that described in Ex. 1B, except that Fe(acac)₂ was used as the metal source instead of Ni(acac)₂.

### Example 3: Synthesis of Nanoframes

Ex. 3A. Synthesis of Cu—Ni Nanoframes: ˜50 mg Cu—Ni polyhedral nanoparticles, ˜5.0 mL of DI water, and ˜2 mL of acetic acid were added to a 25 mL three-neck flask where oxygen was removed by Ar or N₂ blowing for ˜20 min. After about 1 hour to about 24 hours of stirring at about room temperature, the resulting Cu—Ni nanoframes were isolated by centrifuging at about 4000 rpm for about 5 minutes, and the supernatant was discarded. Ethanol (about 10 mL) was then added to the pellet and the mixture was centrifuged at about 4000 rpm for ˜5 minutes. The two washings aid removal of unreacted precursor and other materials. The Cu—Ni nanoframes can be stored in a hydrophilic solvent (e.g., ethanol, methanol and/or acetone).

Ex. 3B. Synthesis of Pt—Cu Polyhedral Nanoframes: ˜50 mg Cu—Ni polyhedral nanoparticles, ˜5.0 mL of octadecene water, and ˜2 mL of oleylamine were added to a 25 mL three-neck flask where oxygen was removed by Ar or N₂ blowing for ˜20 min. Next, ˜4 mL of the Pt⁴⁺-oleylamine stock solution (˜100 mg of H₂PtCl₆.6H₂O dissolved in ˜4.0 mL of oleylamine) was quickly injected into the three-neck flask, the reaction solution was then heated to a temperature of about 80° C. to about 150° C. After about 1 hour to about 24 hours of stirring at about 80° C. to about 200° C., the resulting Pt—Cu nanoframes were isolated by centrifuging at about 4000 rpm for about 5 minutes, and the supernatant was discarded. 1 mL of hexane and ethanol (about 10 mL) were then added to the pellet and the mixture was centrifuged at about 4000 rpm for ˜5 minutes. The two washings aid removal of unreacted precursor and other materials. The Pt—Cu nanoframes can be stored in a hydrophobic solvent (e.g., hexane, toluene and/or chloroform).

Ex. 3C. Synthesis of Pt—Ni Nanoframes—Method 1: ˜50 mg Cu—Ni polyhedral nanoparticles, ˜5.0 mL of octadecene water, and ˜2 mL of oleylamine were added to a 25 mL three-neck flask where oxygen was removed by Ar or N₂ blowing for ˜20 min. Next, ˜4 mL of the Pt⁴⁺-oleylamine stock solution (˜200 mg of H₂PtCl₆.6H₂O was dissolved in ˜4.0 mL of oleylamine) was quickly injected into the three-neck flask, the reaction solution was then heated to a temperature of about 80° C. to about 200° C. After about 1 hour to about 24 hours stirring at about 80° C. to about 200° C., the resulting Pt—Ni nanoframes were isolated by centrifuging at about 4000 rpm for about 5 minutes, and the supernatant was discarded. 1 mL of hexane and ethanol (about 10 mL) were then added to the pellet and the mixture was centrifuged at about 4000 rpm for ˜5 minutes. The two washings aid removal of unreacted precursor and other materials. The Pt—Cu nanoframes can be stored in a hydrophobic solvent (e.g., hexane, toluene and/or chloroform).

Ex. 3D. Synthesis of Pt₃Ni Nanoframes: Pt—Ni seed-core-frame nanostructures (˜8.0 mg) made in Ex. 2A, about 4.0 mL of acetic acid (˜50% volume ratio), and about 1.0 mL of PVP solution (˜2.0 mg/mL) were added to an 8.0 mL vial equipped with a magnetic stir bar and mixed. The mixed solution was sonicated for about 1 minute, and then immersed into an oil bath set at 60° C. for different time periods (˜2 h, ˜6 h, ˜8 h, ˜16 h, and ˜24 h). After the reaction, the product was purified by ethanol and redispersed in water. The products were precipitated out by adding ethanol to the solution and separated by centrifugation at about 5000 rpm for about 2 min. The final product was redispersed in ethanol.

### Example 4: Composition and Structural Characterization of Example Cu—Ni—Pt Nanoparticles

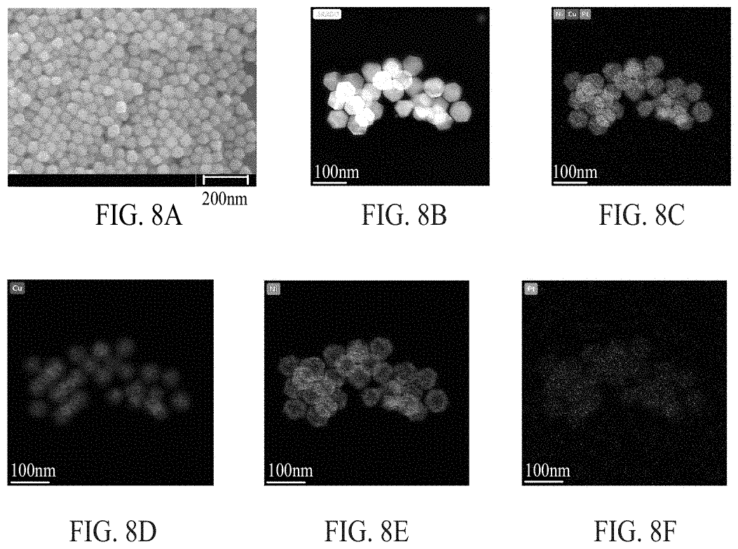

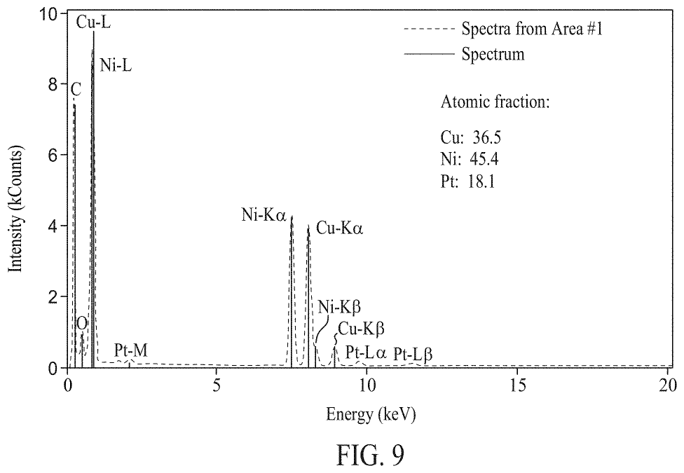

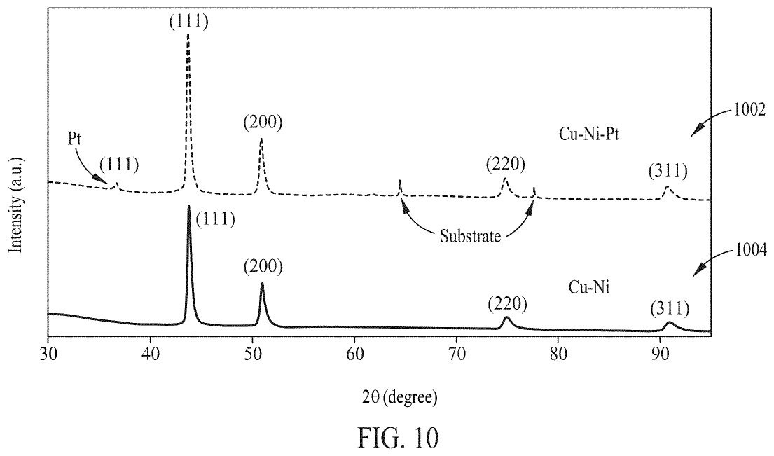

Trimetallic polyhedral nanoparticles, e.g., were synthesized according to methods described herein and characterized by SEM, HAADF-STEM, EDS, and XRD. FIG. 8A shows an SEM image of example Cu—Ni—Pt polyhedral nanoparticles evolved from Cu—Ni rhombic dodecahedron nanoparticles. FIG. 8B shows an exemplary HAADF-STEM image of the example Cu—Ni—Pt polyhedral nanoparticles according to at least one aspect of the present disclosure. FIG. 8C is an exemplary EDS mapping image showing the Cu, Ni, and Pt portions of the example Cu—Ni—Pt polyhedral nanoparticles imaged in FIG. 8B. FIGS. 8D, 8E, and 8F are exemplary EDS mapping images showing the Cu portions, Ni portions, and Pt portions of the Cu—Ni—Pt polyhedral nanoparticles, respectively. FIG. 9 is an exemplary energy dispersive X-ray spectrum of example Cu—Ni—Pt polyhedral nanoparticles according to at least one aspect of the present disclosure. FIG. 10 is an XRD pattern of the example Cu—Ni—Pt polyhedral nanoparticles (1002) evolved from the Cu—Ni rhombic-hexagonal dodecahedron nanoparticles (1004).

The data indicates that the nanostructures include Cu (red) mostly in the core and Ni (green) mostly in the shell of the Cu—Ni—Pt polyhedral nanoparticles. Pt (blue) is in the core and the shell. The EDX spectrum indicated that the atomic fraction of Cu, Ni, and Pt in the example Cu—Ni—Pt polyhedral nanoparticles was about 37%, about 45%, and about 18%, respectively. The XRD pattern shows that the Cu—Ni—Pt polyhedral nanoparticles has peaks at {111}, {200}, {220}, and/or {311}.

### Example 5: Electrochemical Measurements

Electrochemical measurements can be performed using a device such as device 600 shown in FIG. 6. A nitrogen-saturated 0.5 M H₂SO₄ aqueous solution was utilized in a standard three electrode electrolysis cell using electrocatalyst-loaded glassy carbon (diameter ˜5 mm) with an area of ˜0.197 cm² as the working electrode 603, a graphite rod as the counter electrode 605 and an Ag/AgCl electrode as the reference electrode 604. The 0.5 M H₂SO₄ solution, having certain amounts of molecular mediator material 608 therein, is then purged with nitrogen for about 60 min to remove air.

To form the ink, and in some examples, about 5 mg of catalyst (metallic structure 601) and about 5 mg of carbon black are suspended in about 2 mL of isopropanol, about 8 mL of deionized water, and about 100 μL of Nafion solution (5 wt %, Sigma-Aldrich) to form a homogeneous ink assisted by ultrasound. This example to form the ink is a non-limiting illustration as a variety of concentrations and suitable materials can be utilized. Then, about 10 of the ink was spread onto the surface of the glassy carbon by a micropipette and dried at room temperature.

All the electrochemical measurements including cyclic voltammetry (CV), linear sweep voltammetry were performed by using an electrochemical workstation (Biologic). Prior to each polarization curve test, ˜20-30 cycles of CVs were swept at a scan rate of ˜100-500 mV s⁻¹ to stabilize the catalyst and the polarization curves were recorded at a scan rate of ˜1-10 mV s⁻¹. The rotating disk electrode measurements were performed by a Pine Research Instrument.

### Aspects Listing

The present disclosure provides, among others, the following aspects, each of which can be considered as optionally including any alternate aspects:

Clause 1. A composition, comprising:

an electrolyte material or an ion thereof;

an amphiphile material or an ion thereof; and

a metal component, the metal component comprising an alloy having the formula

(M¹)ₐ(M²)_{b},

wherein: M¹ is a Group 10-11 metal of the periodic table of the elements, M² is a first Group 8-11 metal of the periodic table of the elements, M¹ and M² are different, and a and b are positive numbers.

Clause 2. The composition of Clause 1, wherein the alloy further comprises a second Group 8-11 metal that is different from M¹ and M².

Clause 3. The composition of Clause 1 or Clause 2, wherein at least a portion of the metal component is in the form of a nanoframe as determined by HAADF-STEM.

Clause 4. The composition of any one of Clauses 1-3, wherein the metal component has an average particle size from about 10 nm to about 400 nm as measured by TEM.

Clause 5. The composition of any one of Clauses 1-4, wherein:

the first Group 8-11 metal comprises Fe, Ru, Os, Co, Rh, Ir, Ni, Pd, Pt, Cu, Ag, or Au;

the Group 10-11 metal comprises Ni, Pd, Pt, Cu, Ag, or Au;

the second group 8-11 metal, if present, comprises Fe, Ru, Os, Co, Rh, Ir, Ni, Pd, Pt, Cu, Ag, or Au; or combinations thereof.

Clause 6. The composition of Clause 5, wherein the first Group 8-11 metal comprises Ni or Cu.

Clause 7. The composition of any one of Clauses 1-6, wherein the electrolyte material comprises an acid or ion thereof.

Clause 8. The composition of Clause 7, wherein the acid has a pKa of about 3 or less.

Clause 9. The composition of any one of Clauses 1-8, wherein the electrolyte material comprises H₂SO₄, HNO₃, H₃PO₄, HCl, HI, HBr, or combinations thereof.

Clause 10. The composition of any one of Clauses 1-9, wherein the amphiphile material has the formula:

X—Y⁻Z⁺,X—Y⁻, or a combination thereof,

wherein:
X comprises unsubstituted hydrocarbyl, substituted hydrocarbyl, unsubstituted alkenyl, substituted alkenyl, unsubstituted aryl, or substituted aryl;
Y⁻ comprises

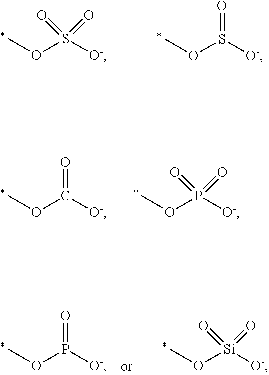

where “*” represents X; and
Z⁺, if present, comprises Li, Na, K, Rb, Cs, Mg, Ca, Al, or combinations thereof.

Clause 11. A device, comprising:

an electrolyte material or ion thereof;

an amphiphile material or ion thereof; and

a metal component disposed on an electrode, the metal component comprising a bimetallic nanoframe, a trimetallic nanoframe, or a combination thereof.

Clause 12. The device of Clause 11, wherein the bimetallic nanoframe has the formula

(M¹)ₐ(M²)_{b},

wherein:
M¹ is a Group 10-11 metal of the periodic table of the elements,
M² is a Group 8-11 metal of the periodic table of the elements,
M¹ and M² are different, and
a and b are positive numbers.

Clause 13. The device of Clause 12, wherein:

M¹ is Fe, Ru, Os, Co, Rh, Ir, Ni, Pd, Pt, Cu, Ag, or Au; and

M² is Ni, Pd, Pt, Cu, Ag, or Au.

Clause 14. The device of Clause 12, wherein:

M¹ is Ni or Cu; and

M² is Pd, Pt, Ag, or Au.

Clause 15. The device of any one of Clauses 11-15, wherein the trimetallic nanoframe has the formula:

(M³)ₑ(M⁴)_{f}(M⁵)_{g},

wherein:
M³ is a Group 10-11 metal of the periodic table of the elements,
M⁴ is a Group 8-11 metal of the periodic table of the elements,
M⁵ is a Group 8-11 metal of the periodic table of the elements,
M³, M⁴, and M⁵ are different, and
e, f, and g are positive numbers.

Clause 16. The device of Clause 15, wherein:

M³ is Fe, Ru, Os, Co, Rh, Ir, Ni, Pd, Pt, Cu, Ag, or Au;

M⁴ is Ni, Pd, Pt, Cu, Ag, or Au; and

M⁵ is Ni, Pd, Pt, Cu, Ag, or Au.

Clause 17. The device of any one of Clauses 11-17, wherein:

the bimetallic nanoframe has a polyhedral shape with a substantially hollow interior as determined by HAADF-STEM;

the trimetallic nanoframe has a polyhedral shape with a substantially hollow interior as determined by HAADF-STEM; or

a combination thereof.

Clause 18. A process for converting water to a conversion product, comprising:

introducing an electrolyte material and an amphiphile material with a metal component to form a mixture comprising a catalyst composition, the metal component comprising a Group 10-11 metal and at least one Group 8-11 metal; and applying a voltage to the catalyst composition to form the conversion product.

Clause 19. The process of Clause 18, wherein the amphiphile material is in the form of a solution comprising an amphiphile material having the formula:

X—Y⁻X—Y⁻, or a combination thereof,

wherein:
X comprises unsubstituted hydrocarbyl, substituted hydrocarbyl, unsubstituted alkenyl, substituted alkenyl, unsubstituted aryl, or substituted aryl;
Y⁻ comprises

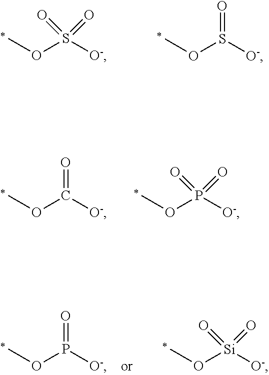

where “*” represents X; and
Z⁺, if present, comprises Li, Na, K, Rb, Cs, Mg, Ca, Al, or combinations thereof.

Clause 20. The process of Clause 18 or Clause 19, wherein the electrolyte material is in the form of an aqueous solution comprising an acid, the acid having a pKa of about 3 or less.

Clause 21. A process for converting carbon dioxide to a conversion product, comprising: introducing carbon dioxide to the device according to any one of Clauses 11-17; and obtaining the conversion product.

Aspects described herein generally relate to catalyst compositions, processes for producing such catalyst compositions, and uses of such catalyst compositions in, e.g., devices and processes for producing conversion products. The catalyst compositions contain, e.g., a bimetallic nanoframe and/or trimetallic nanoframe. The defects of the nanoframe(s) can be utilized to increase the efficiency and catalytic activity in various conversion reactions.

As used herein, a “composition” can include component(s) of the composition and/or reaction product(s) of two or more components of the composition. Compositions of the present disclosure can be prepared by any suitable mixing process.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a metal” include aspects comprising one, two, or more metals, unless specified to the contrary or the context clearly indicates only one metal is included.

While the foregoing is directed to aspects of the present disclosure, other and further aspects of the disclosure may be devised without departing from the basic scope thereof, and the scope thereof is determined by the claims that follow.

What is claimed is:

1. A composition, comprising:
an electrolyte material or an ion thereof;
an amphiphile material or an ion thereof; and
a metal component, the metal component comprising an alloy having the formula
(M¹)ₐ(M²)_{b},
wherein:
M¹ is a Group 10-11 metal of the periodic table of the elements,
M² is a first Group 8-11 metal of the periodic table of the elements,
M¹ and M² are different, and
a and b are positive numbers.

2. The composition of claim 1, wherein the alloy further comprises a second Group 8-11 metal that is different from M¹ and M².

3. The composition of claim 1, wherein at least a portion of the metal component is in the form of a nanoframe as determined by HAADF-STEM.

4. The composition of claim 1, wherein the metal component has an average particle size from about 10 nm to about 400 nm as measured by TEM.

5. The composition of claim 1, wherein:
the first Group 8-11 metal comprises Fe, Ru, Os, Co, Rh, Ir, Ni, Pd, Pt, Cu, Ag, or Au;
the Group 10-11 metal comprises Ni, Pd, Pt, Cu, Ag, or Au;
the second group 8-11 metal, if present, comprises Fe, Ru, Os, Co, Rh, Ir, Ni, Pd, Pt, Cu, Ag, or Au; or
combinations thereof.

6. The composition of claim 5, wherein the first Group 8-11 metal comprises Ni or Cu.

7. The composition of claim 1, wherein the electrolyte material comprises an acid or ion thereof.

8. The composition of claim 7, wherein the acid has a pKa of about 3 or less.

9. The composition of claim 1, wherein the electrolyte material comprises H₂SO₄, HNO₃, H₃PO₄, HCl, HI, HBr, or combinations thereof.

10. The composition of claim 1, wherein the amphiphile material has the formula:
X—Y⁻Z⁺,X—Y⁻, or a combination thereof,
wherein:
X comprises unsubstituted hydrocarbyl, substituted hydrocarbyl, unsubstituted alkenyl, substituted alkenyl, unsubstituted aryl, or substituted aryl;
Y⁻ comprises 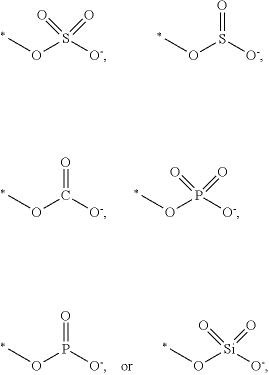
where “*” represents X; and
Z⁺, if present, comprises Li, Na, K, Rb, Cs, Mg, Ca, Al, or combinations thereof.

11. A device, comprising:
an electrolyte material or ion thereof;
an amphiphile material or ion thereof; and
a metal component disposed on an electrode, the metal component comprising a bimetallic nanoframe, a trimetallic nanoframe, or a combination thereof.

12. The device of claim 11, wherein the bimetallic nanoframe has the formula
(M¹)ₐ(M²)_{b},
wherein:
M¹ is a Group 10-11 metal of the periodic table of the elements,
M² is a Group 8-11 metal of the periodic table of the elements,
M¹ and M² are different, and
a and b are positive numbers.

13. The device of claim 12, wherein:
M¹ comprises Fe, Ru, Os, Co, Rh, Ir, Ni, Pd, Pt, Cu, Ag, or Au; and
M² is Ni, Pd, Pt, Cu, Ag, or Au.

14. The device of claim 12, wherein:
M¹ is Ni or Cu; and
M² is Pd, Pt, Ag, or Au.

15. The device of claim 11, wherein the trimetallic nanoframe has the formula:
(M³)ₑ(M⁴)_{f}(M⁵)_{g},
wherein:
M³ is a Group 10-11 metal of the periodic table of the elements,
M⁴ is a Group 8-11 metal of the periodic table of the elements,
M⁵ is a Group 8-11 metal of the periodic table of the elements,
M³, M⁴, and M⁵ are different, and
e, f, and g are positive numbers.

16. The device of claim 15, wherein:
M³ is Fe, Ru, Os, Co, Rh, Ir, Ni, Pd, Pt, Cu, Ag, or Au;
M⁴ is Ni, Pd, Pt, Cu, Ag, or Au; and
M⁵ is Ni, Pd, Pt, Cu, Ag, or Au.

17. The device of claim 11, wherein:
the bimetallic nanoframe has a polyhedral shape with a substantially hollow interior as determined by HAADF-STEM;
the trimetallic nanoframe has a polyhedral shape with a substantially hollow interior as determined by HAADF-STEM; or
a combination thereof.

18. A process for converting water to a conversion product, comprising:
introducing an electrolyte material and an amphiphile material with a metal component to form a mixture comprising a catalyst composition, the metal component comprising a Group 10-11 metal and at least one Group 8-11 metal; and
applying a voltage to the catalyst composition to form the conversion product.

19. The process of claim 18, wherein the amphiphile material is in the form of a solution comprising an amphiphile material having the formula:
X—Y⁻Z⁺,X—Y⁻, or a combination thereof,
wherein:
X comprises unsubstituted hydrocarbyl, substituted hydrocarbyl, unsubstituted alkenyl, substituted alkenyl, unsubstituted aryl, or substituted aryl;
Y⁻ comprises 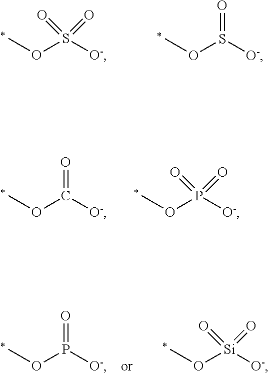
where “*” represents X; and
Z⁺, if present, comprises Li, Na, K, Rb, Cs, Mg, Ca, Al, or combinations thereof.

20. The process of claim 18, wherein the electrolyte material is in the form of an aqueous solution comprising an acid, the acid having a pKa of about 3 or less.
